(19) United States
(12) Patent Application Publication
(10) Pub. No.: US 2017/0124291 A1
(43) Pub. Date: May 4, 2017

(54) INTERACTIVE GRAPHIC ELECTRONIC CLINICAL STUDY MANAGEMENT

(71) Applicant: ISRAEL BARKEN, SAN DIEGO, CA (US)

(72) Inventor: ISRAEL BARKEN, SAN DIEGO, CA (US)

(21) Appl. No.: 14/574,390

(22) Filed: Dec. 17, 2014

Related U.S. Application Data
(63) Continuation-in-part of application No. 14/479,302, filed on Sep. 6, 2014, now abandoned.

(51) Int. Cl. G06F 19/00

(52) U.S. Cl. CPC G06F 19/363; G06F 19/322; G06F 19/3418

(57) ABSTRACT

In one example, the present invention relates to a method for managing information specific to a patient, said method including: (a) providing: (i) a home screen having a first dimension and a second dimension, an icon that is connected to patient-specific information, and a time line that defines time points along the first dimension; (ii) a supporting document of patient-specific information; (iii) an admin screen for entering, editing, downloading, or uploading patient-specific information; (iv) a means for accessing patient-specific information associated with a single date or a range of dates; (v) a chronological data report; and (vi) a first signal, a second signal, and a third signal; and (b) contacting on the home screen: (i) the icon with the first signal for accessing the supporting document; (ii) the icon with the second signal for accessing the admin screen; or (iii) the means for accessing patient-specific information associated with a single date or a range of dates with the third signal for accessing the chronological data report of patient-specific information associated with the single date or the range of dates.

This application is a continuation-in-part application and claims the benefit of U.S. Ser. No. 14/479,302, filed September 6, 2014, the entire disclosure of which is herein incorporated by reference.

### BACKGROUND OF THE INVENTION

The field of the present invention relates generally to the field of medicine and, in particular, relates to a method for keeping medical records so that the user can obtain a maximum amount of medical information from the first screen of an electronic medical record system.

Medical service organizations have developed electronic formats to replace the traditional paper-based medical charts kept for each patient. The potential benefits of a well-designed electronic medical chart could not be plainer: readable information that is readily shared between medical providers of the same patient should enhance a patient's treatment and care. Unfortunately, currently available electronic formats do not efficiently convey relevant information in sufficient breadth and depth on the entry screen, thereby requiring the medical professional seeking to learn the medical status of a patient to have to hunt through the electronic chart virtually no differently than would have occurred using a paper format chart. Moreover, difficulties abound when medical professionals associated with different organizations working on the same patient seek to compare notes and data using their respective organization's electronic medical charts: The systems of different medical service organizations typically do not allow direct data sharing and the like.

The present invention solves these problems and thus heightens the efficiency of providing the current medical status of a patient to each medical professional serving a given patient. The present invention also takes a distinctly different approach to the electronic medical chart from that of all others known to the present inventor: Noting that the medical data of a patient is the property of the patient, the electronic medical chart disclosed herein presumes that the patient has control of his medical information and encourages his or her active use of it. Further improvements to the electronic medical chart concept will be readily perceived upon review of the following detailed discussion of the present invention including presentation of exemplifications of the invention as presented in the accompanying figures.

### SUMMARY OF THE INVENTION

The present invention provides a method for managing information specific to a patient, said method comprising (A) providing (i) a home screen having a first dimension and a second dimension, an icon that is connected to patient-specific information, and a time line that defines time points along the first dimension; (ii) a supporting document of patient-specific information; (iii) an admin screen for entering, editing, downloading, or uploading patient-specific information; (iv) a means for accessing patient-specific information associated with a single date or a range of dates; (v) a chronological data report; and (vi) a first signal, a second signal, and a third signal; and (B) contacting on the home screen (i) the icon with the first signal for accessing the supporting document; (ii) the icon with the second signal for accessing the admin screen; or (iii) the means for accessing patient-specific information associated with a single date or a range of dates with the third signal for accessing the chronological data report of patient-specific information associated with the single date or the range of dates. In one embodiment, the first signal is a left-click on a standard computer mouse; the second signal is a right-click on a standard computer mouse. In another embodiment, the admin screen has administrative functions relating to inputting, editing, uploading, downloading, and generating data, documents, or communications; in certain embodiments, the admin screen is provided in alternative versions specific for entering, editing, downloading, or uploading information directed at diagnoses and allergies, lab tests results, diagnostic events, procedures, one-time events and extended events, medications and supplements, life styles, side effects, orders and requests, reports, and communications. The admin screen can include fields for entry of specific data, including, without limitation intended, (a) subject of patient-specific information, (b) quantitative data, (c) initial date, (d) ending date, (e) orders or requests, (f) remarks, and/or (g) side effects.

This method can entail the home screen being viewable as a single page; and supporting documents and reports of patient data being accessed directly from the home screen. This method can further entail the patient-specific information being selected from the group consisting of a one-time event, a long-tern event, and a communication; wherein the one-time event is selected from the group consisting of a one- or two-day procedure, a diagnostic test, a surgery, and an office visit. Moreover, the long-term event can be selected from the group consisting of administration of a drug, a supplement, a physical therapy, an induced coma, and physical exercise.

The present invention includes the communication being selected from the group consisting of an order, a request, a note to file, an electronic mail (email), an audio file, an audio email, a video file, and a video email. In one embodiment, the present invention further includes the supporting document being selected from the group consisting of a laboratory report of a test, a post-operative report, physician notes of an office visit, an email, an output from a diagnostic machine, and an order.

The present invention, in another embodiment thereof, includes a slidable line that moves along the first dimension and intersects the time line, wherein one means for accessing patient-specific infonnat associated with a single date comprises selecting the slidable line and moving it to a pre-selected date on the time line, followed by contacting the slidable line with the third signal; wherein, further, the first signal and the third signal are the same in certain embodiments of the invention. In some embodiments, the slidable line can split into a first slidable line and a second slidable that move along the first dimension and intersect the time line, wherein the means for accessing patient-specific information associated with a range of dates comprises (a) selecting the first slidable line and moving it to a pre-selected date on the time line, (b) selecting the second slidable line and moving it to a second pre-selected date on the time line, and (c) contacting the first slidable line or the second slidable line or the region there between with the third signal.

The present invention can further provide a second slidable line that moves along the first dimension and intersects the time line, wherein the means for accessing patient-specific information associated with a range of dates comprises (a) selecting the slidable line and moving it to a pre-selected date on the time line, (b) selecting the second slidable line and moving it to a second pre-selected date on the time line, and (c) contacting the slidable line or the second slidable member or the region there between with the third signal.

In another embodiment, the present invention can further provide a group data report, wherein contacting the icon with the second signal results in access to the group data report of patient-specific information that was generated similarly but on different dates.

The present invention can also include a registration screen for entering identifying information of the patient and, optionally, one or more other persons with whom the patient elects to share his patient-specific information, in whole or in part. In a typical embodiment of the present invention, at least one of the other persons includes a medical professional.

In another embodiment of the present invention, the registration screen includes a drop menu for selecting a module that is specific for an area of medical practice, wherein the range of alternative selections for the plurality of drop-down menus differs in accordance with the module that is selected.

Overall, the present invention can include a display of information specific to a patient,comprising: (a) a time line; (b) a line graph of continuous variable data; (c) an event icon; (d) a bar graph of time during which a long-term event occurs; and (e) a report or note icon; wherein the time line, the line graph, the event icon, the bar graph, and the report or note icon appear in concert on a home screen. In some embodiments of the present invention, the display further comprises a communication icon that symbolizes communication selected from the group consisting of an email, an audio file, an audio email, a video file, and a video email; and wherein the communication icon takes different forms for distinguishing different forms of communication. Generally, in certain embodiments of the present invention, if the note includes an order or a request for a new therapy or a change in an existing therapy, then a warning icon is displayed. In certain embodiments, the line graph, event icon and communication icon are positioned with respect to the time line. As a general rule, but not necessarily applicable to all embodiments, the continuous variable data are derived from patient measurements pursuant to at least one diagnostic test that is repeated over time thereby generating a plurality of patient measurement data points. The diagnostic test employed in the context of the present invention can measure a blood component selected from the group consisting of prostate-specific antigen (PSA), cardiac troponin, high density lipid (HDL), glycohemoalobin (HbAlc), low density lipid (LDL), PAP, prolactin, testosterone, total cholesterol, triglycerides, blood cells, and a liver enzyme. In some embodiments of the present invention, the time interval between generating successive patient measurement data points is substantially the same.

The graphical representation of a set of patient measurement data points of a first diagnostic test describes a curve that is determined by the patient measurement data points generated by the first diagnostic test. The graphical representation of a multiplicity of sets of patient measurement data determine a corresponding multiplicity of curves that are each distinguishably represented, wherein each set of patient measurement data is derived from a different diagnostic test. The present invention, in yet another embodiment, provides a third page that includes a report containing patient measurement data, which patient measurement data is employed to generate the graphical representation.

In yet another embodiment of the present invention, an admin page appears in response to a user contacting a communication icon with a second signal, which admin page includes means for entering, editing, downloading, or uploading the communication event and access to programs for generating a new communication event. In an alternative embodiment, the present invention comprises an admin page that includes means for entering, editing, downloading, or uploading patient measurement data.

The present invention also includes an event icon that symbolizes an event selected from the group consisting of a diagnostic procedure, a therapeutic procedure, a mental trauma, a physical trauma, and a general event. The diagnostic procedure is generally selected from the group consisting of a bone density test, a bone scan, an oxygen saturation test of lung tissue, a pleural fluid sampling, a pulmonary function, a sputum evaluation, an arterial blood flow, a venous ultrasound, an echocardiogram, an electrocardiogram, an exercise stress test, a bone marrow biopsy, a lymph node biopsy, a fecal occult blood test, a liver biopsy, a kidney biopsy, an X-ray, a CAT scan, an MRI, a hormone assay, and a colonoscopy. The therapeutic procedure is generally selected from the group consisting of physical therapy (PT), chemotherapy, radiation therapy, hormone therapy, gene therapy, cell therapy, and drug therapy. The mental trauma is generally selected from the group consisting of death of a spouse or first degree relative, a medical challenge to a spouse or first degree relative, a change in employment, a change in marital status, and a change of residence. The general event is selected from the group consisting of a medical consult, a psychiatric or psychological consult, an office visit, and an emergency room visit.

In certain embodiments, the event icon is an icon or acronym that represents the event; the bar graph displays a segment or ongoing portion of the time line and relates to a long-term event selected from the group consisting of a diagnostic procedure, a therapeutic procedure, a side effect caused by a procedure, a hospital stay, a rehabilitation center stay, and a detox center stay; the long-term event that has not yet ended is denoted by a horizontal bar that has an arrow pointing toward future points along the time line; the therapeutic procedure is selected from the group consisting of a course of a therapeutic drug, radiation therapy, chemotherapy, physical therapy, allergy treatment, food restriction, hormone therapy, or cell therapy, and a hospital stay; the diagnostic procedure is a course of ultrasound, hormone assays, liver enzyme assays, cardiac troponin assays, glycohemoglobin assays, blood sugar assays, blood cell counts, or blood factor assays; the event icon denotes the diagnostic procedure, the therapeutic procedure, the side effect, the hospital stay, the rehabilitation center stay, or the detox center stay.

As generally used in the context of the present invention, a supporting document appears in response to a user contacting a data-representing element selected from the group consisting of the line graph, the event icon, the bar graph, the report or note icon, and the communication icon with a first signal, which supporting document includes information relating to data represented by the data-representing element; an admin screen appears in response to a user contacting the data-representing element with a second signal, which admin screen includes means for entering, editing, downloading, or uploading information relating to the information represented by the data-representing element; the communication is between the patient and at least one medical professional and includes one or more communication means selected from the group consisting of an electronic mail (email), a scanned note on paper, an audio recording, a video email, and a video recording; and the display is in electronic communication with a server, a first repository of patient data., a second repository ofmedical information, and an input device.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth the various elements of the present invention and expands further upon those elements by presenting certain illustrative embodiments, in which the principles of the invention are utilized, which illustrative embodiments are shown in the accompanying drawings, of which:

FIG. 1A illustrates one embodiment of a home screen of a patient's electronic medical chart of the present invention, wherein the home screen displays the medical status of the patient with reference to (1) a line graph of repeated tests, (2) a bar graph of extended events, which bars are disposed horizontally, (3) a recital of one-time events, which recitals are disposed vertically, (4) a recital of reports and notes, and, optionally, (5) a recital of communication events that can be displayed or hidden from sight by the clicking of a hide/show toggle that appears on the home screen.

FIG. 1B illustrates one embodiment of a “pop-up” screen for a five-column table of Diagnostics, Medications, Events, Communications and Remaining Icons (appears in response to contacting a signal to the INPUTS SELECTOR button) for selecting the categories of data that appear on the home screen.

FIG. 2A illustrates one embodiment of a registration screen for entering or editing personal information of the patient and contact information for those individuals with whom the patient elects to share his/her medical information; such individuals are commonly medical professionals, but may also include lay people.

FIG. 2B illustrates one embodiment of a “pop-up” screen for selecting modules for different areas of medicine (appears in response to contacting a signal to the MODULES button), which are selected by the user to accommodate the specialized data appropriate for the different practice areas, as appropriate for whatever medical challenges that are impacting the user.

FIG. 3A illustrates one embodiment of an admin screen for entering or editing clinical data of the patient that relates to the patient's vitals relevant to all areas of medicine.

FIG. 3B illustrates one embodiment of an admin screen for entering or editing clinical data of the patient that relates to the patient's vitals relevant to all areas of medicine generally and in addition provides a form for additional clinical data relevant to treatment of a carcinoma of the prostate.

FIG. 3C illustrates one embodiment of an admin screen for entering or editing clinical data of the patient that relates to the patient's vitals relevant to all areas of medicine generally and in addition provides a form for additional clinical data relevant to gynecological treatment.

FIG. 4 illustrates one embodiment of an admin page for entering or editing diagnoses and/or allergies specific to the patient.

FIG. 5 illustrates one embodiment of an admin screen for entering, editing, or accessing laboratory test results to be included in the electronic medical chart.

FIG. 6 illustrates one embodiment of an admin screen for entering results from diagnostic tests.

FIG. 7 illustrates one embodiment of an admin screen for entering or editing results of a procedure of diagnosis or therapy ordered by a medical professional treating the patient.

FIG. 8 illustrates one embodiment of an admin screen for entering events having a medical impact into the electronic medical chart. Both one-time events (e.g., an office visit, a blood test, a sleep study, an out-patient surgical procedure or other event that takes place over the course of up to two days) and long-term events (e.g., a course of medicinal therapy, physical therapy, etc.) are included.

FIG. 9 illustrates one embodiment of an admin screen for entering or editing side effects that may have arisen in the context of a procedure of diagnosis or therapy ordered by a medical professional treating the patient.

FIG. 10 illustrates one embodiment of an admin screen for entering or editing an order provided by a medical professional or a request provided by the patient or the medical professional to the other.

FIG. 11 illustrates one embodiment of an admin screen for entering or editing a report or a note written to the medical smart chart.

FIG. 12 illustrates one embodiment of an admin screen for entering, editing or receiving a communication, which communication can be a fax, an email, an audio file, a video file, a chat, a word processing document in any format, or a scanned document that is located on the user's local computer or downloaded from a secure cloud file.

FIG. 13 illustrates one embodiment of an admin screen for entering or editing medications and supplements taken by the patient.

FIG. 14 illustrates one embodiment of an admin screen for entering or editing life style choices that the patient indicates are being followed.

FIG. 15 illustrates one embodiment of an admin screen for entering or editing reminders, warnings, and alerts.

FIGS. 16A and 16B illustrate embodiments of chronological data reports that display a list of supporting documents in chronological order and include those documents that support data appearing on the home screen at a specific date or range of dates, respectively.

FIG. 17 illustrates one embodiment of a system that can be employed to implement the interactive graphic electronic medical chart of the present invention.

FIGS. 18A, 18B, and 18C show combined logic and data flow block diagrams depicting interaction between a 1^{st} User and the interactive graphic electronic medical chart of the present invention.

FIGS. 19A, 19B, 19C, 19D, 19E, and 19F show combined logic and data flow block diagrams depicting one embodiment of the interactive graphic electronic clinical study management tool as set forth herein.

FIG. 20 shows one embodiment of a summary screen relating to a patient's participation in a clinical study as used in the context of the interactive graphic electronic clinical study management tool, wherein the summary screen displays the medical status of the patient with reference to (1) a line graph of repeated tests and clinical evaluations, (2) a bar graph of extended events, which bars are disposed horizontally, (3) a recital of one-time events, which recitals are disposed vertically, (4) a recital of reports and notes, and, optionally, (5) a recital of communication events that can be displayed or hidden from sight by the clicking of a hide/show toggle that appears on the home screen.

### DETAILED DESCRIPTION OF THE INVENTION

In one example, the present invention comprises a method and materials for interacting with a screen displaying patient-specific medical information where all input data is organized with reference to a time line. As used herein, a “screen” refers to a single page as displayed on a standard desktop computer monitor; in contrast, smaller displays, as used in the context of a smart phone or tablet or other handheld devices, may have to be manipulated (i.e., scrolled up-down or left-right) to see all of the patient-specific medical information that can be viewed in concert on one's desktop computer. Furthermore, icons employed to represent respective input data are themselves linked to: (a) respective supporting documents, (b) respective alternative screens where the data can be edited, removed, printed, and the like, (c) respective chronological data reports, and (d) respective group data reports, as further described below.

From the home screen, which is fully described below, a user can view a patient's current medical status and prognosis with immediate and direct access to: (i) means for communicating between the patient and any lay person or medical professional selected by the patient or between any two or more of the medical personnel and/or lay persons who have been given permission to discuss the patient's private medical information; and (ii) all input data, supporting documents, listings of the supporting documents, all diagnostic tests and orders and procedures and communications with reference to the patient, which documents and listings are presented chronologically with reference to a range of dates on the time line of the home screen, or with reference to a particular one of the above, or with reference to a grouping of a certain variety of the above. The home screen itself is alternatively referred to as the Medical Smart Chart screen (“the MSC screen”). As well, the overall system including all connected screens as well as the hardware and software that together comprise the invention is referred to herein as the MSC system.

These interrelated features of the interactive electronic medical chart of the MSC system, in one embodiment, are set forth below with reference to the set of definitions of those terms contained in a Definitions subsection below. The Definitions subsection shall govern for defining the terms included there unless another subsection or example includes language that specifically defines the term otherwise, in which case the alternative definition shall be limited to the described feature.

What is described, in the main, is one embodiment of the present invention as presented with reference to the figures. The figures exemplify plainly the novel features of displaying in a single screen the broad array of a patient's medical data and history, all tied to the same time line. A skilled viewer of the single screen can immediately grasp the patient's medical status without need to hunt for additional information as if the patient's medical chart was yet in paper form. Included in the history, of course, are medical events, such as office visits, diagnostic or therapeutic procedures, and the like. Also included in a patient's history are personal events that may have lasting medical effects, such as loss or illness of a first degree relative, loss of employment, declaration of bankruptcy, or other events having significant impact. For any of the events, treatments, and tests represented by the various icons on the home screen, the viewer can see the actual support document by simply clicking on a particular icon. Accordingly, a patient's entire medical history and current status are represented on the single-page home screen and the skilled clinician viewing that history and current status can spot check any aspect that presents to him or her a question by a single click of a mouse and review the actual report from the official source (commonly a physician or testing laboratory). No hunting through a paper chart to find the reports or heading through a maze of electronic layers is required. Indeed, it is this increased efficiency in use of an electronic chart that most marks this invention's utility.

Those skilled in the art can readily vary specific elements of the described embodiment without advancing a new concept, meaning that the inventor contemplates that his invention may be employed in the context of many alternative embodiments that vary in one or more of the features of the present invention in minor or insubstantial ways. One category of minor or insubstantial difference is rearrangement of placement on the screen of the various components of the medical data. Other such categories involve changes to the icons used, the range of Line Graph values, the intervals displayed on the time line, and the like. Accordingly, including one or more standard design alternatives on one or more of the screens or substituting a technology employed in the MSC system where the substitute technology passes the function, way, result test for equivalents are contemplated extensions of the inventor's claimed method employing the MSC page in the context of the MSC system.

More particularly, described herein is a method for managing information specific to a patient, the variety of screens employed in the method, and a system for implementing the method. The method includes a number of steps, such as: providing (i) a home screen having a first dimension and a second dimension, (ii) a multiplicity of icons that are respectively connected to patient-specific information, and (iii) a time line that defines time points along the first dimension. The dimensions of any screen disclosed herein are substantially the horizontal and vertical dimensions where the first dimension is commonly the horizontal such that the aforementioned time line is situated where the earlier dates are to the left and the later dates are to the right.

The method includes providing a supporting document of patient-specific information. The supporting document can take many forms, including, without limitation intended, a written report of a blood test or panel of blood tests, a video directed at results of a pathology analysis, an audio file presenting a genetic analysis, a radiograph, a photograph, an electrocardiogram, an orally-presented operative report, a physician's or patient's written note to file, a written report of an office visit, a request from the patient or medical professional to the other, a physician order (necessarily in writing with signature due to current requirements), a written consulting physician's report, and the like. The supporting document can be stored in any suitable computer format including, without limitation, pdf, doc, rtf, txt, jpg, way, mp4, and the like.

The icons can have any form, including, without limitation, any geometric shape, cartoon character, sketch, alphanumeric character, and the like, and can be highlighted or distinguished by color, underlining, italic- or bold-form, and the like. A single icon can represent a generic grouping of supporting documents, e.g., a sketch or cartoon of a speaker (e.g., “ [symbol] ”) can symbolize audio communications, a sketch or cartoon of a camera (e.g., “ [symbol] ”) can symbolize video communications, a sketch or cartoon of a file folder (e.g., “ [symbol] ”) can symbolize a physician's order or request, a sketch or cartoon of a circled capital i (e.g., “ [symbol] ”) can symbolize a patient's request for information or further explanation, a sketch or cartoon of a notepad (“ [symbol] ”) can symbolize a note to the chart, an ampersat (“@”; also known as an “at sign”) can symbolize electronic mail communications, a combined sketch or cartoon of a speaker or a camera with an ampersat, i.e., [symbol] or [symbol] , respectively, can symbolize an audio email or video email communication, a double exclamation point (e.g., “!!”) can symbolize warnings or reminders, a red line underscoring of a representation of an extended event can symbolize associated side effects, a horizontal bar can symbolize continuous use or practice of a medicine or treatment, the symbol “+” or a sketch of a circled capital M (e.g., “\textcircled{M}”) can symbolize a medicinal treatment irrespective whether a prescription drug or nonprescription drug or nutritional supplement, a circled capital p (e.g., “\textcircled{P}”)can symbolize a procedure, a question mark (e.g., “?”) can symbolize a diagnostic test or procedure, a circled one (e.g., “\textcircled{1}”) can symbolize a one-time event (such as an office visit or an ischemic event), a capital Greek letter delta (“Δ”) can symbolize data not yet input, geometric symbols (e.g., solid or open circles ( or ◯), diamonds (♦ or ⋄), squares (▪ or □), triangles (▴ or Δ), and the like) can represent data points on a line graph (where the triangle symbols can be readily distinguished from the Greek letter delta in that only the triangle symbols for data points would be connected by lines on a line graph).

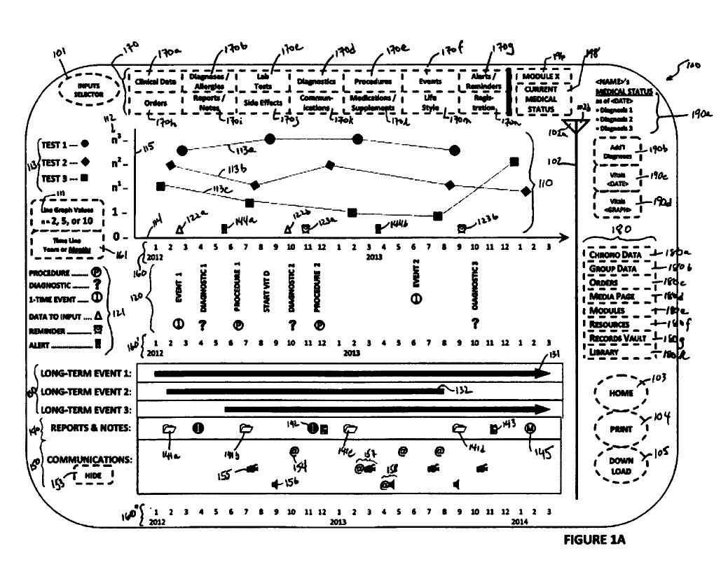

Each of the icons are placed on the home screen with reference to a time line signifying the date of occurrence or period of occurrence; such indicators are used predominantly for one-time events, such as an office visit, a car accident, a diagnostic test, or another event of short duration that occurs over at most a two day period and has or may have ongoing medical impact. The one-time event data are listed vertically starting with the category-identifying icon and followed by the specific name. For example, at a point in the first dimension signifying the date that the patient had a blood test for prostate-specific antigen (“PSA”) level, the icon indicating a diagnostic test would appear (e.g., a question mark (?) in the embodiment illustrated in FIG. 1A) and vertically above the question mark would appear the acronym PSA where DIAGNOSTIC 2 appears on FIG. 1A (presuming that the patient had blood drawn that was tested for PSA concentration in October of 2012). Similarly, one can insert information relating to a particular procedure (e.g., a hernia repair or an angioplasty) such that the generic icon for procedures (i.e., \textcircled{P}, as exemplified above) would appear along the first dimension at a point consistent with the date on which the event occurred, along with additional information identifying the specific procedure.

Longer term events are represented in a bar chart on the home screen, where the bar chart, in one embodiment, is disposed horizontally. An icon indicating the category of long-term event can be displayed adjacent the start of the bar, or anywhere else along the length of the bar, and the specific long-term event can be disclosed adjacent the bar in a fashion that the name of the long-term event will remain irrespective of the time frame along the time line that is being observed. A long-term event that is ongoing to the present time is generally indicated by inclusion of an arrow at the right-hand end of the horizontal bar; in contrast, a long-term event that has terminated is generally indicated by the horizontal bar stopping at or about the relevant time point, where the right-hand end of the bar ends squared off, or with a terminal circle, or with a vertical bar.

A communication event sent on a given date will be represented by a suitable icon, e.g., an ampersat (@) for an email, a camera symbol ( [symbol] ) for a video conference, or combined icons for an audio email ( [symbol] ) or a video email ( [symbol] ) located along the first dimension at a point signifying the date that the communication was sent. Other discrete-in-time events include diagnostics and out-patient procedures, symbols for which also appear on the home screen with reference to the time line to indicate date of occurrence. Useful other information that may be included are start and stop dates of a treatment that is otherwise presented in the bar chart (to show duration of the treatment, which is a long-term event). The section of the home screen displaying the communication events is optionally included on the home screen; or is included on the home screen in a manner such that it can be displayed or hidden by the clicking of a toggle located on the home screen.

One can also alter the set of data to be displayed on the home screen by raising a second screen employed for selecting the set of diagnostic data, medications, events, and/or communications to be displayed in concert. As well, one can select different intervals of time that will be displayed on the home screen, as appropriate for the focus believed to serve the patient's interests and concerns best.

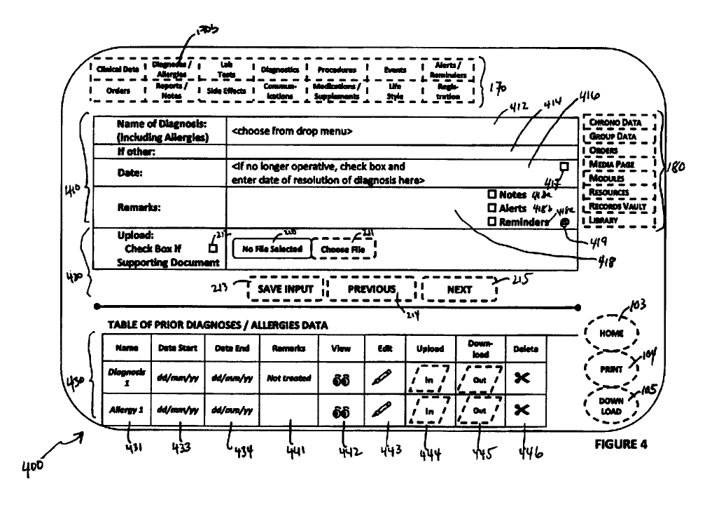

The method also includes providing an admin screen for entering, editing, or uploading data from a supporting document. Different admin screens are appropriately included to reflect differences in the inputs pertaining to various sorts of patient-specific medical data, which are further discussed below. See FIGS. 4-15, as examples of one set of admin screens used in the context of the present invention.

Each supporting document is connected by a hyperlink technology to an icon representing a specific datum (or set of data) or a specific category of patient-specific information, which exemplary icons were presented above.

As a general principle of the interactive graphic medical chart of the present invention, one contacts an icon with a first signal for seeking the supporting document that is connected to the icon, and a second signal for seeking the admin page crafted with reference to the category of patient-specific information represented by the particular icon in contact with the second signal. The position that an icon occupies is defined in part by the date assigned to the patient-specific information; accordingly, an icon representing patient-specific information that occurred earlier will be located on that place of the first dimension that is coincident with the earlier date and, of course, patient-specific information occurring later will be located at a place along the first dimension that represents the later time point. The first signal and the second signal can be any suitable signal so long as it is spatially orientable, that is, the computer being capable of perceiving a signal associated with a particular location in two dimensions on the display by virtue of the programming of its operating system, the placement of the cursor over the situs of a particular icon in combination with the implementation of a signal perceived by the computer results in the effect of calling forth either a supporting document or an admin page associated with the particular icon, depending whether the signal was a first signal or a second signal, respectively. Accordingly, placement of the cursor at the particular location of an icon and depressing a particular key or combination of keys on a keyboard can suffice, as can depressing the left or right button on a computer mouse, where, in some embodiments, the computer is further programmed to distinguish between single- and double-clicks (or depressions) of the left or right button; moreover, for those computer mice that include a depressible roller, it too can be used as a spatially-orientable signal. In addition, for displays comprised of a touch-sensitive material, the signal, in addition or in the alternative, can be a single-versus a double-touching of the site using one's finger or a stylus suitable for touching a computer display.

In the embodiments exemplified here, the first signal is generally provided by depressing the left button on a computer mouse and the second signal is generally provided by depressing the right button thereof.

Contacting the icon with a second signal (in the exemplified embodiments hereof, a right-click on a computer mouse) results in the admin screen appearing where the data entered from the supporting document represented by the icon will be filled in the form of the admin screen. Moreover, each admin screen includes a group data report toward the bottom of the display, whereof the supporting document represented by the signal-contacted icon will be listed in the report at the top of the list and/or highlighted for ready selection.

As noted above, there are many categories of patient-specific information that can be input into the present electronic medical chart. The categories include blood test results, generally displayed in the context of a line graph. Also displayed are one-time events, such as surgeries and other procedures, the start of a medication regime, a diagnostic test, and the like. Long-term events are also shown in the interactive graphic medical chart, generally displayed in the context of a bar chart. Icons for reports and notes, as well as inquiries from patient to physician, and vice versa, are arrayed in accordance with the time line. Finally, various direct communications are also listed on the home screen, using icons that clearly denote current methods of communication, again arrayed in accordance with the time line.

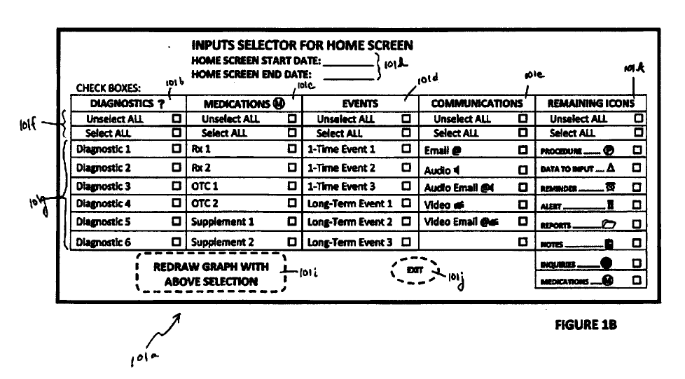

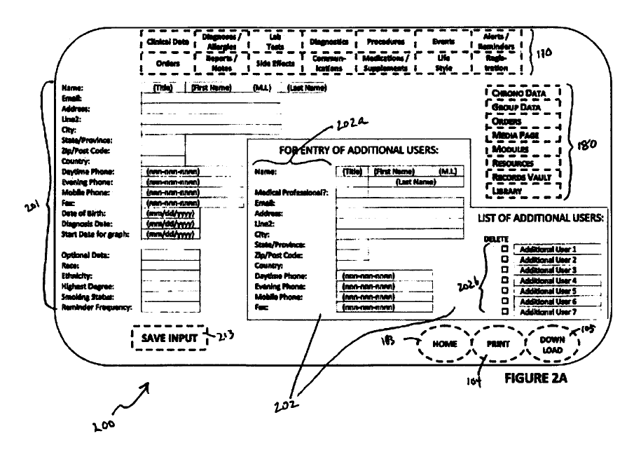

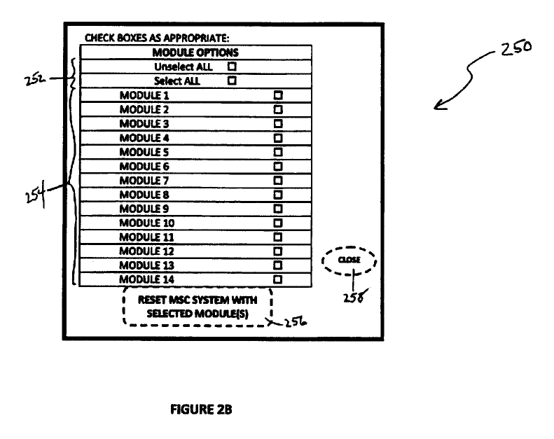

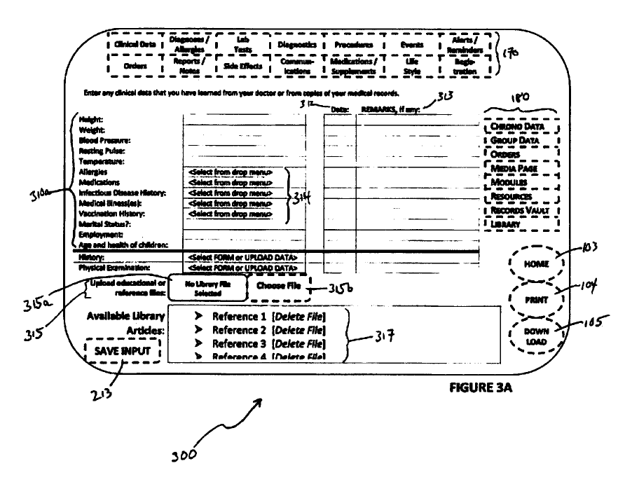

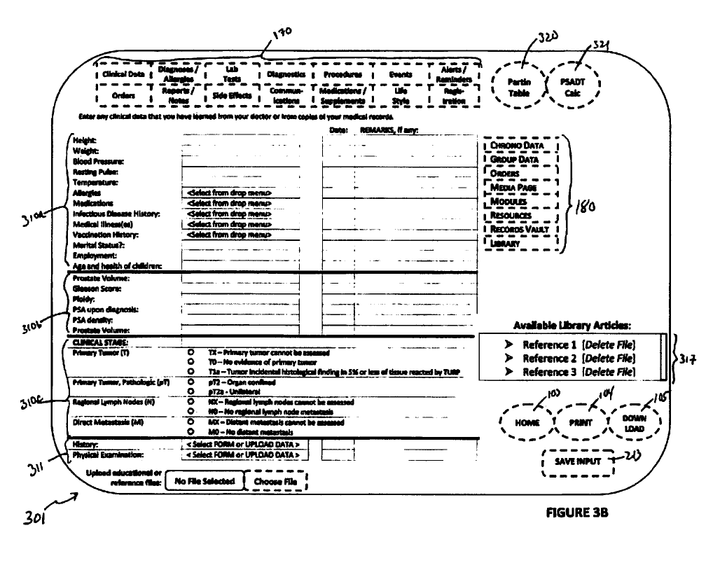

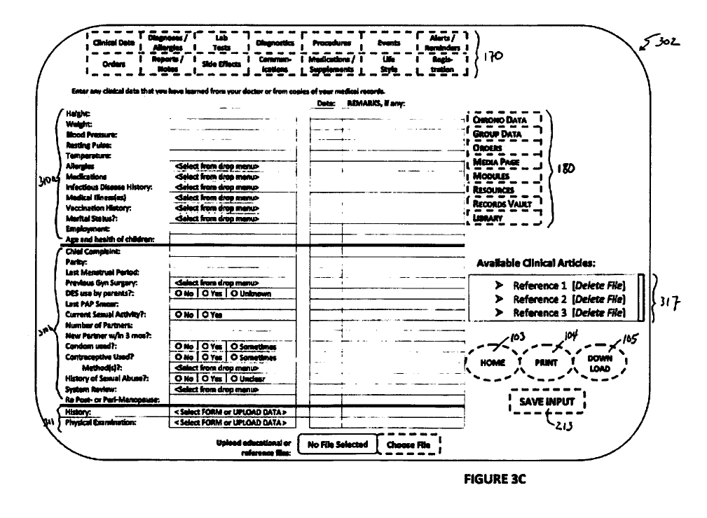

Aspects of the present invention may be understood with additional particularity in reference to the figures that illustrate one of the embodiments of the present invention. Turning to FIG. 1A that illustrates one embodiment of a home screen 100 as employed in the present invention, note that common features to the home screen, administration screen (e.g., FIG. 2A), clinical data screen (e.g., FIGS. 3A, 3B, or 3C), and all admin screens (e.g., FIGS. 4-15) are two sets of hyperlinked buttons. The first set of hyperlinked buttons 170 (horizontally disposed in the illustrated embodiment) is directed at screens for inputting, editing, uploading or downloading data, referred to as a whole as admin screens. The second set of hyperlinked buttons 180 (vertically disposed in the illustrated embodiment) is directed at screens of reports or listings of literature or communications means or practice areas that can be selected for viewing or altering the screens of the MSC System.

With respect to the first set of hyperlinked buttons, Table 1 sets forth the button identifier as shown in FIG. 1A (the same button identifiers used in all subsequent figures), the name of the hyperlinked screen, and the figure where that particular admin screen is illustrated.

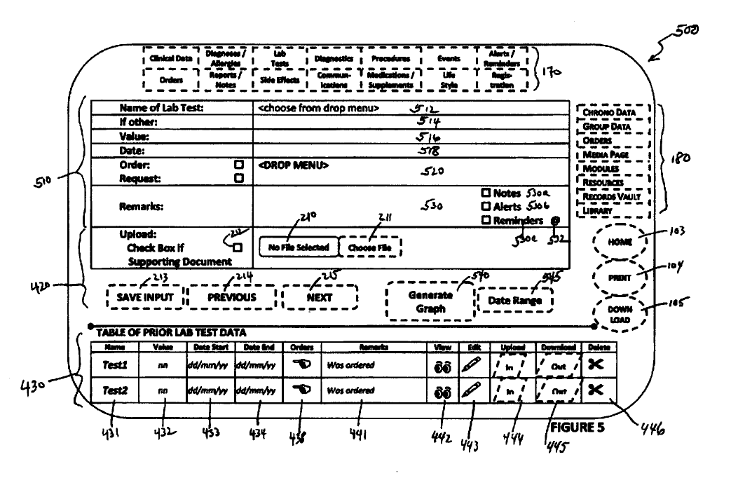

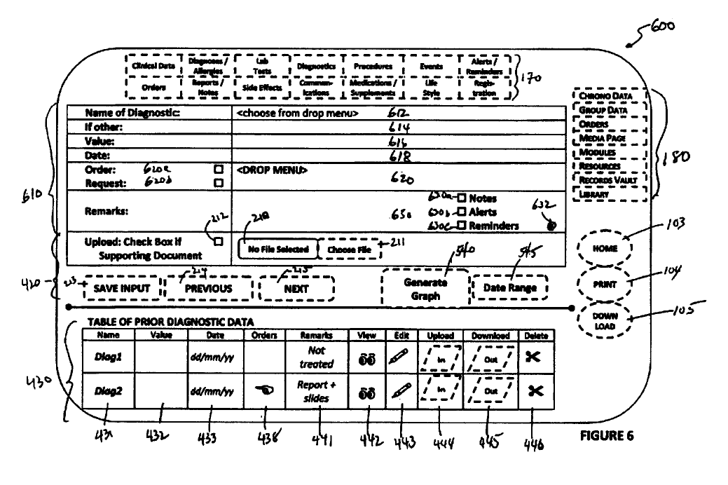

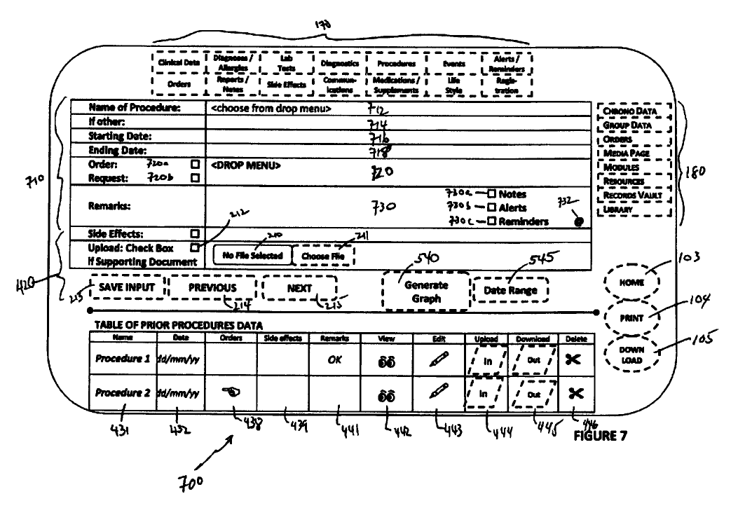

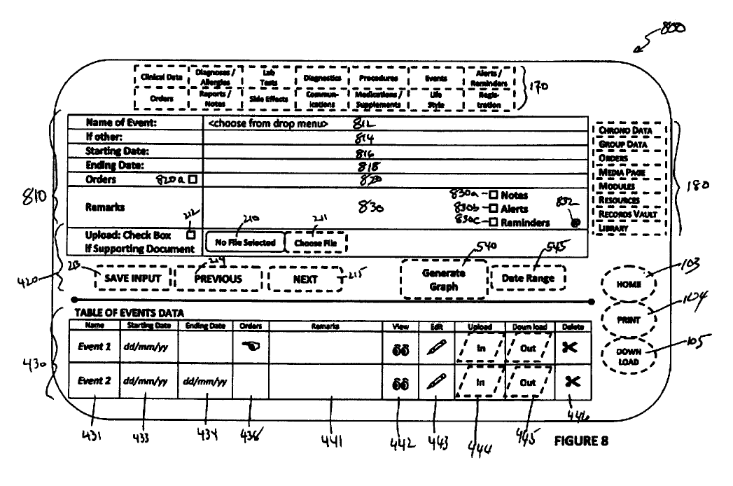

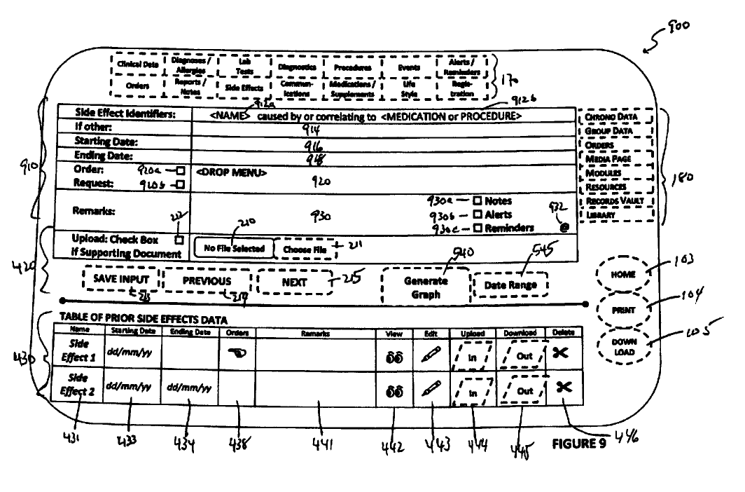

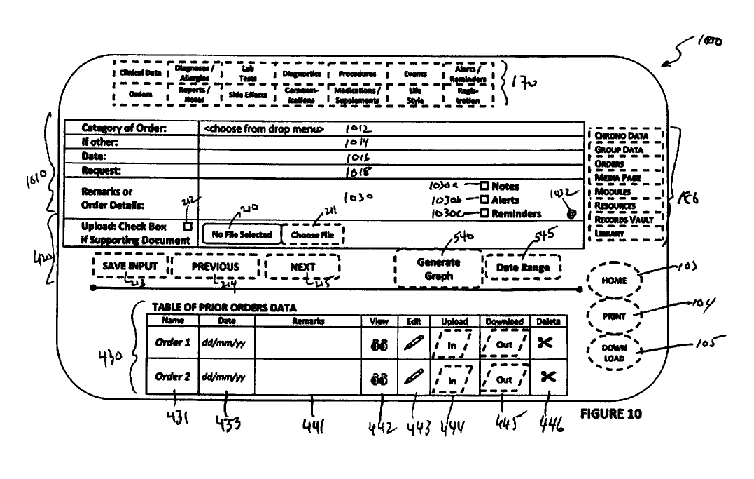

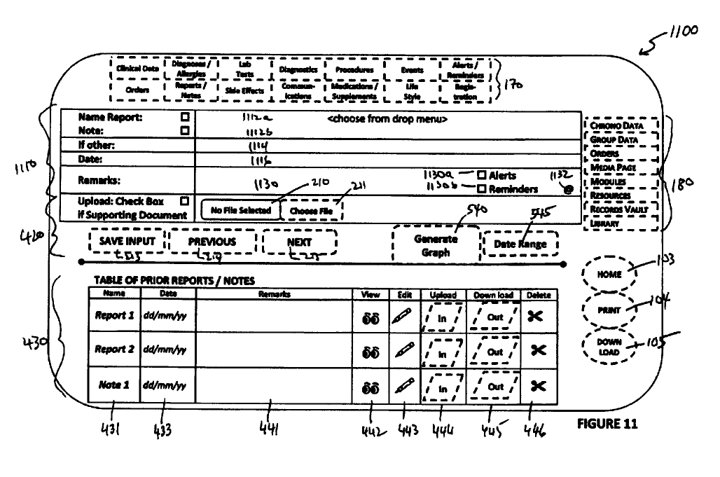

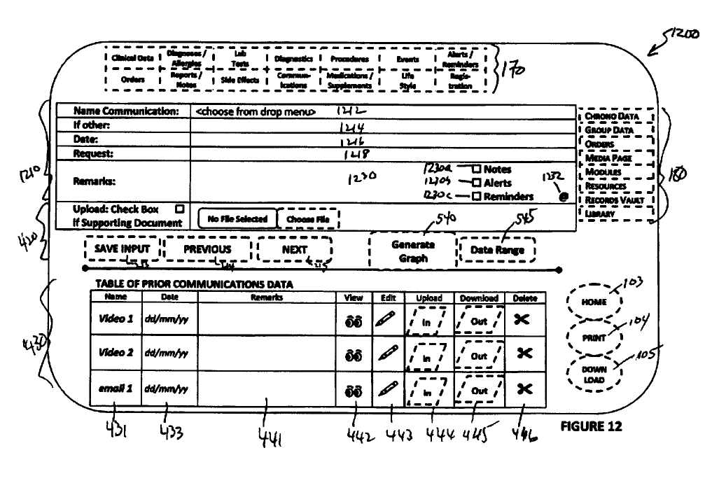

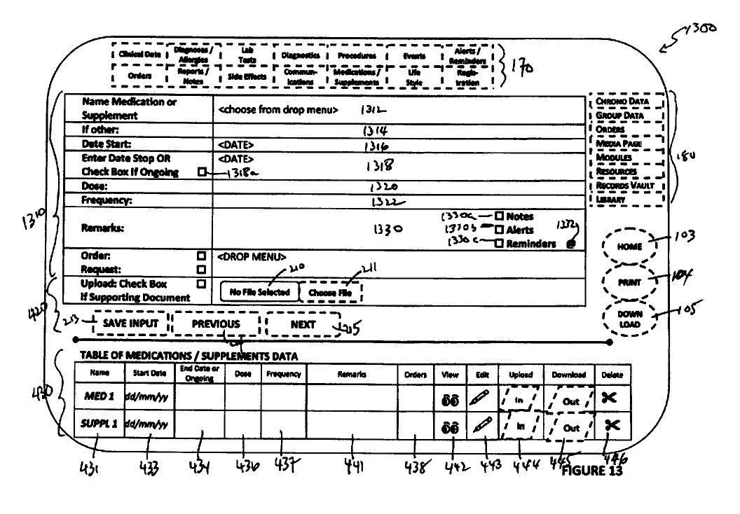

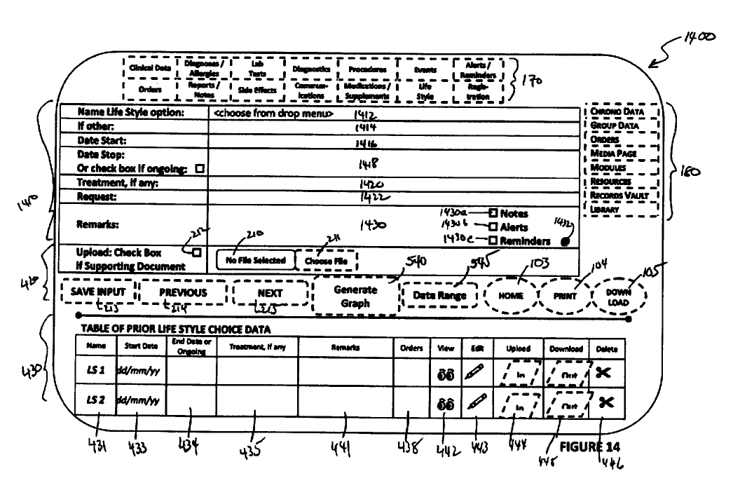

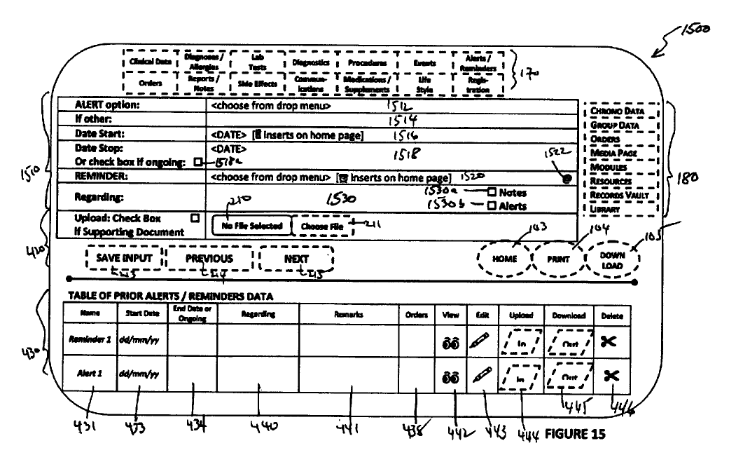

TABLE 1
Concordance of Data Entry/Edit Screens and Figures

| Identifier | Name of Admin Screen | Illustration(s) |
|---|---|---|
| 170a | Clinical Data Admin Screen | FIGS. 3A, 3B, 3C |
| 170b | Diagnoses/Allergies Admin Screen | FIG. 4 |
| 170c | Lab Tests Admin Screen | FIG. 5 |
| 170d | Diagnostics Admin Screen | FIG. 6 |
| 170e | Procedures Admin Screen | FIG. 7 |
| 170f | Events Admin Screen | FIG. 8 |
| 170g | Alerts/Reminders Admin Screen | FIG. 15 |
| 170h | Orders Admin Screen | FIG. 10 |
| 170i | Reports/Notes Admin Screen | FIG. 11 |
| 170j | Side Effects Admin Screen | FIG. 9 |
| 170k | Communications Admin Screen | FIG. 12 |
| 170l | Medications/Supplements Admin Screen | FIG. 13 |
| 170m | Life Style Admin Screen | FIG. 14 |
| 170n | Administration Admin Screen | FIG. 2A |

These admin screens have a number of utilities, but perhaps foremost is the function of uploading support documents into the MSC System as well as the site for entering the data from the support documents. These two events, i.e., uploading support documents and entering data there from, commonly will occur at the same time, but need not. One can upload the support document using the admin screen appropriate to the information contained in the support document, which ties the support document to the category of data intended to be dealt with using the particular admin screen. The same support document, of course, can contain data appropriate to a number of different categories of data, such as a received email communication that includes a physician's reasoning concluding a particular diagnosis. In that case, the same support document, i.e., the email, would be properly uploaded at the Communications Admin Screen as well as the Reports/Notes Admin Screen. In the embodiment illustrated in the attached figures, one indeed would upload the same support document twice in the scenario just stated; in other embodiments, one would enter the support document just once and a pop-up would appear on the screen that would permit the user to indicate all categories of data represented in the support document so that the same document would be associated with each indicated category. In yet another embodiment of the present invention, a server to which the uploaded support document would be headed for analysis would read the document, automatically select the categories of data included therein, and, furthermore, automatically enter the contained data as appropriate as if done manually by a user using each of the admin screens, as appropriate. But, as to the embodiment shown in FIG. 1A et seq., the has the choice of entering the contained data immediately following the upload procedure using one of the admin screens; or it can be done at any point later in time.

Of course, it is better for the data to be input as soon as possible so that the information is available to a subsequent user of the MSC System for benefit of the particular patient. For that reason, the MSC System includes an icon that will appear on the time line of section 110 for a support document whose information has not been entered. The icon is a capital Greek letter delta Δ 122, which resides directly upon the time line coincident with the date or dates that the information included in the support document were generated. Thus, one can see in FIG. 1A that a capital delta Δ 122a appears on the time line of section 110 consistent with a date in February of 2013, suggesting that a support document having information generated in February 2013 has or may have information that is yet to be entered into the MSC System. Again, the capital delta icon (A) is used here as an indicator icon that a support document for a particular content of patient medical data has been uploaded into the MSC System, but its content has not yet been entered.

A user wanting to input the data would contact the delta icon with a first signal, which would be a left-click when using a standard computer mouse in the instant embodiment, in which case the document would appear as a “floating” window on the screen; and, a second signal (or right-click of the mouse in the context of the instant embodiment) would result in the connected admin screen or screens also appearing for entry of the data. In one embodiment of the present invention, the “floating” window screen remains visible, i.e., remains on top of the admin screen, and is substantially transparent allowing the user to see through it to all parts of the admin screen. For this alternate embodiment, one can enter data in any region of the admin screen that is set up for that purpose, irrespective of the location of the support document in its floating window format; that is, the cursor can be manipulated by the mouse to any location on the admin page and key entry of data can occur thereafter even if the floating support document is directly overhead. The floating support document cannot be written upon, only viewed and consulted to assure accurate entry of the information onto the admin screen. Once the information of the support document has been entered, the MSC System removes the capital delta icon from the x-axis 114.

The support document can also be viewed by clicking on the highlighted identifier of the document found in the group report section of the admin screen, in which case, as before, the supporting document whose data remained to be entered would float in the presence of the open admin screen.

In addition, given that the value of the support document is highly limited if its included information is not entered, the MSC System also places a reminder icon (i.e., an alarm clock [symbol] 123) coincident with the date that the support document was uploaded. As can be seen in FIG. 1A, section 110, a second capital delta icon Δ 122b appears on the x-axis 114 indicating that it contains information generated in February 2013 that is yet to be entered into the appropriate admin screen. Adjacent to the second capital delta icon, there appears a reminder icon [symbol] 123a whose purpose is to remind the user to do something. Its location on the x-axis 114 represents the day the reminder request was itself generated or scheduled (more on this point when the Alerts/Reminders Admin Screen is discussed). In this instance, the reminder icon serves to remind the user to enter the data contained in the support document represented by capital delta icon 122b. To learn what it is that a reminder icon is intended to remind one of, one would contact the reminder icon with a second signal (i.e., a right-click of a mouse) and the Alert/Reminder Admin Screen would appear with the information. Thereupon, one would then click on the appropriate admin screen button among section 170, find the document of interest among the group report at the bottom of the admin page, click on the line of the support document of interest in the group report, whereupon the support document would appear in a floating form; and a right-click on the document line would cause the admin page to appear onto which the data would be entered.

It is worth restating the working of the reminder icon: A reminder icon [symbol] can be placed anywhere along the x-axis of section 110. To learn just what the reminder icon refers to, the user would contact the reminder icon with a signal, for example a second signal or right-click, and in response the Alerts/Reminders Admin Screen (as illustrated in FIG. 15 for the herein-described embodiment) would appear on the user's display which would provide the appropriate information.

Regardless of the way one goes to bring forth the support document whose information remains to be entered, the support document remains in its floating form such that the user can refer to it while inputting the data into the appropriate admin screen.

With respect to the second set of hyperlinked buttons, Table 2 sets forth the button identifier as shown in the vertical grouping of hyperlinked buttons in FIG. 1A (again, the same button identifiers used in all subsequent figures), the name of the hyperlinked screen, and the figure where that screen is exemplified.

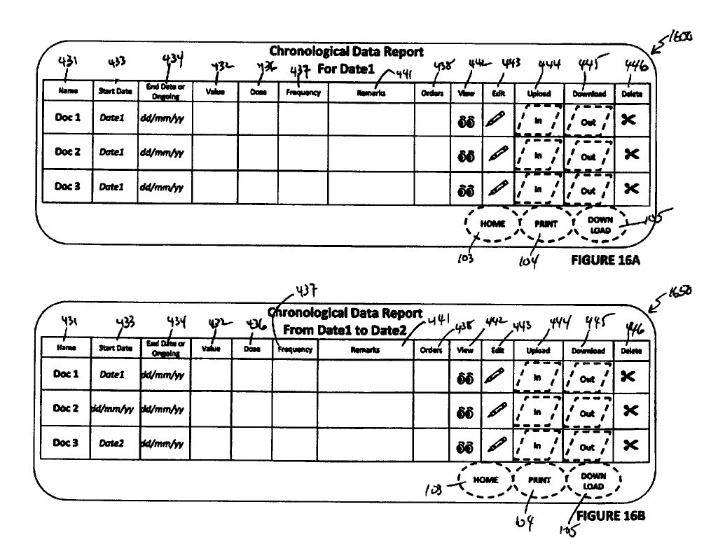

TABLE 2
Concordance of Report and Selection Screens and Figures

| Identifier | Name of Report/Selection Screen | Illustration(s) |
|---|---|---|
| 180a | Chronological Data Report | FIGS. 16A, 16B |
| 180b | Group Data Report | Not Shown |
| 180c | Orders Report | Not Shown |
| 180d | Media Page | Not Shown |
| 180e | Module(s) Selection | FIG. 2B |
| 180f | Resources | Not Shown |
| 180g | Records Vault | Not Shown |
| 180h | Library | Not Shown |

The documents and locations to which these buttons serve as effective conduits for the user will be further described below.

Also present on all screens of the MSC System are three hot buttons 103, 104, and 105 directed, respectively, at returning to the home screen, printing the currently viewed screen, and downloading the currently viewed screen, which are three self-explained functions. These three hot buttons are generally disposed at the lower right quadrant of any given screen in the embodiment illustrated in the figures accompanying this specification; but, of course, these hot buttons can be located anywhere on the various screens. They may be disposed horizontally or vertically, but generally remain in the same order left to right or top to bottom.

Personal medical data of at least four categories are presented on the home screen of the MSC System, namely test or diagnostic data presented in a first section 110, one-time events presented in a second section 120, long-term events presented in a third section 130, and reports and notes presented in a fourth section 140. In addition, a fifth category of personal medical data, namely communications files and documents, is included in a fifth section 150 as the default; however, contacting button 151 with any signal results in the communications section 150 being hidden; a subsequent contact of button 151 with a signal results in the communications section 150 reappearing.

There is also a section 190 for reciting the current medical status of the patient, where, in one embodiment, there appears a date for time of last update of this section, a listing of current diagnoses, a button for calling up a pop-up window of additional information re the patient's current medical status, and a second button for calling up a window of the patient's latest set of vitals data.

The first section 110 presents diagnostic test data in the context of a line graph where each data point, as illustrated by the embodiment shown in FIG. 1A, is placed with respect to a time line 160 that provides the units of the x-axis 114 and also with respect to the value of each iteration of the diagnostic test in accordance with the scale 112 presented as the units for the y-axis 115. The data points for a given test are represented by the same icon that, in this instance, is a simple geometric form; here, a closed circle, diamond, or square as noted by the legend 113 for Tests 1-3.

The range of values of the y-axis 115 or time of the x-axis 114 can be varied. In the instance of the y-axis range, a logarithmic scale is used where base number n can be selected as 2, 5, or 10, raised to exponents of 0, 1, 2, and 3; accordingly, the y-axis scale is logarithmic ranging in absolute numbers between 0 up to 8, 125, or 1000 by selecting one of the three base numbers n presented by the selector button 111. The selector button 111 works by clicking on that button, whereupon a window (not shown) emerges with the three choices for the number n; using the cursor as maneuvered by the computer mouse or other selector apparatus of the electronic device used to access the MSC System, the user simply highlights the desired base number n and clicks on it. In response, the values on the scale of the y-axis change in accordance with the selected base number n, as follows: If n=2, then the numbers replacing n¹, n², and n³ on the y-axis will be 2, 4, and 8, respectively; if n=5, then the respective numbers will be 5, 25, and 125; and if n=10, then the respective numbers will be 10, 100, and 1000. Other embodiments of the MSC System can use a linear scale for the values of the y-axis, using any range appropriate to the values generated by the particular diagnostic test used; which linear range can be established by selection of the smallest and largest numbers wanted on the y-axis whereupon, using the y-axis 112 as shown in FIG. 1A as an example where the y-axis 115 is divided into four equal segments, the difference between the smallest and largest values is divided by four and the values of the upper ends of each of the four segments is then labeled accordingly. Of course, different embodiments can use other ranges of smallest and largest values for the y-axis, using a linear or log or other category of scale; and can provide a sliding scale of variation or, as in the instant embodiment, a determined set of values from which the user can choose.

Similarly, the time line can be expanded to display data collected over a greater period of time or contracted to display data collected over a lesser period of time. In the embodiment shown on FIG. 1A, the user can select the smaller time segment (which is shown on the time line 160) where a two year segment of time is displayed with indications for each of the 24 months included in that period of time. Alternatively, the user can click on the time line range selector 161, whereupon a choice is presented between the illustrated two-year range and a range of six years where each year is represented by four quarters such that each of the two years shown on FIG. 1A would be replaced by three each. The starting year for either the two year or the six year range time line is separately selected from the time line range selector (detail not shown, but readily set up by any ordinarily skilled artisan in the field). Other embodiments can use other ranges for the timeline, including a sliding scale that would allow the x-axis 114 to have literally any range from a single day, week, month, year, or decade to a number of days, weeks, months, years, or decades as elected by a user seeking to review the set of data that reveals information helpful in analyzing a patient's current or past medical status.

The second section 120 presents various events that generally occur over a one to two day period. For ease of identifying the category of event, icons can be used that are generic identifiers for, for example, a procedure (indicated in the illustrated embodiment by an encircled P), a diagnostic test (indicated by an emboldened question mark), a treatment (indicated by an encircled T), and, for any of the myriad short-term events, a one-time event icon is an encircled 1. As shown in FIG. 1A, the descriptors for the one-time events are disposed vertically and placed along the first dimension of the home screen with reference to the time line. An icon can appear here without a word descriptor; and, as well, a word descriptor can be employed without an icon.

To learn what is indicated by a free-standing icon, for example a circle-P icon as included in section 120, one would right-click on the icon resulting in the Procedures Admin Screen appearing (as illustrated in FIG. 7 for the here-described embodiment), where the supporting document represented by the icon would appear highlighted in the group report section 302 of the admin screen. The same procedure results in the appropriate admin screen arising with the corresponding support document highlighted among the group report at the bottom of each admin page.

The third section 130 presents long-term events where the time during which these events are or were in play are shown by way of a bar graph disposed horizontally. For those long-term events that remain ongoing to the present, the right-hand end of the appropriate bar ends with an arrow head 131. In contrast, those long-term events that have terminated can be determined by the bar ending at a time point prior to the present, ending with a blunt-end 132 or T-end (not shown).

The fourth section 140 is reserved for reports and notes, which are represented by a folder sketch 141 for reports and a notepad 143 for, well, notes. Also shown in this area are symbols for alerts (shown as double exclamation points, as in !! 144), medication (shown as a circled capital M 145), and inquiries (usually from patient to medical professional, shown as an encircled capital I 142).

The fifth section 150 displays various icons for communication events. These icons are optionally visible or not depending on whether the user has clicked on the hide toggle 151 that is located to the immediate left of the communications (or fifth) section 150 of the home screen illustrated on FIG. 1A. If the toggle 151 was last clicked when the communication information was not visible, then section 150 displaying icons for the various sorts of communications will be viewable on the home screen as currently presented in FIG. 1A, in the area immediately below the reports & notes section 140; and if the toggle 151 was last clicked when the communication information was visible, then naturally the communications icons of section 150 will not be visible. The inclusion of the fifth section is contemplated as optional for the present invention where some embodiments will include it with the show/hide toggle 151, others will include it without the show/hide toggle 151 (in which case the communications icons would always be present on the home screen), and in yet other embodiments the communications icons would be omitted.

All of the icons and data points noted above are entered on the home screen with respect to a time line 160, which can appear alone along the first dimension (i.e., as shown in the current embodiment, the horizontal dimension). The time line can also be repeated at various positions on the home screen, such as with respect to a second time line 160′ and/or a third time line 160″, to facilitate identifying the date of origin of the various data represented by icons at different points on the home screen 100. The time lines 160, 160′, and 160″ display the same range of time, which range can be expanded to show a larger set of data over a period of more than two years or contracted to show a smaller set of data over a period limited to only two years by clicking on the years/months toggle 161, as shown in FIG. 1A. In other embodiments, the time lines 160, 160′, and 160″ can vary in range from a single day through multiple years using a continuously variable scale potentiated by a sliding switch (not shown) that can be built into the software for the home screen using methods known in the art.

Turning to FIG. 1B, the Inputs Selector For Home Screen 101a (also referred to as the inputs selector screen 101a) is a pop-up feature that arises upon signaling the Inputs Selector button 101 found at the upper left of the home screen 100 (shown on the upper right corner of FIG. 1A). By filling in the inputs selector screen 101a, one can design a subset of patient-specific data over a stated interval of time (identified by filling in dates in section 101h) best suited for addressing a particular condition being reviewed. The user can select from the various categories of data the desired specific diagnostics (listed in column 101b), medications (listed in column 101c), events (listed in column 101d), or communications (listed in column 101e) to be included on the home screen by checking the appropriate box in section 101g of the inputs selector screen 101a. If all of the data of one or more of the categories of data are wanted to be included, the user can check the Select ALL box of the appropriate column(s) in section 101f; conversely, if none of the data of one or more of the categories of data are desirably included, then the user can check the Unselect ALL box of the appropriate column(s) in section 101f. Once the user has filled in the four columns, as appropriate for the particular issue to be addressed, then the user causes the graph included in section 110 of the home screen to be redrawn by clicking on the button 101i labeled Redraw Graph With Above Selection. And if the user, having opened the inputs selector screen 101a, realizes that there is no need to address limiting the data to be presented on the home screen, the user can simply exit from the inputs selector screen 101a by clicking on the exit button 101j.

Now turning to FIG. 2A, the patient or, more broadly, first user (1^{st} User) (if, for example, someone other than a patient begins use of the MSC System on behalf of a patient) fills in a form included on the Registration admin screen 200 that appears upon contacting the Registration button 170n with a second signal, i.e., a right-click of a computer mouse in the context of the embodiment presented in the attached figures. On the Registration admin screen 200, one sees the same horizontally disposed set of hyperlinked buttons 170 as well as the same vertically disposed set of hyperlinked buttons 180. The user enters, in section 201, contact information, date of birth, diagnosis date for a disease or condition under current treatment, start date for the graphs and event data included on the home screen, certain optional data, and desired frequency for reminder messages. Also included on the Registration form typically filled in at the start of using the MSC System is a section 202 for entry of additional users (in the first column 202a) and a running list of such additional users (in the second column 202b). The additional users are those selected by the patient who may view the patient's private medical information as included in the MSC System. The patient may also delete any of the additional users by simply checking the appropriate delete box adjacent the additional user to be excluded as listed in the second column 202b. In addition, the patient can limit the category of information that a given additional user may view by selecting exclusions using, for example, a pop-up screen directed at such (not shown).

Different practice areas are better served with variations in forms and drop menus with respect to clinical evaluations, medications, and procedures. Accordingly, when filling in the registration form is a perfect time to select one or more modules with respect to current diagnoses or concerns, but can be selected later as well. The “Module Options” screen 250 is shown in FIG. 2B, which can be addressed when using the MSC System by clicking on the “Modules” button 180e found on the vertical set of hyperlink buttons 180 on virtually any screen of the MSC System. The various modules represented symbolically in section 254 of FIG. 2B can include any of the following as appropriate modules: Cardiology; Gynecology; Gastroenterology; and the like. To select all or none of the various modules, one can place a check in the check box of section 252 indicating to unselect all or, if all modules relate to conditions or diseases of the patient, select all. Once the desired practice modules have been selected by placement of a check in the check box adjacent the desired practice module(s), the various screens employed in the context of the MSC System are reset by clicking upon button 256, here titled “Reset MSC System With Selected Module(s)”. To leave the Module Options screen 250 without making any change from what was in place prior to addressing this screen, the user can click upon the Close button 258.

Another module that can be selected in the context of the MSC System relates to automating selection of and participation of patients in a clinical study. The MSC System, in one embodiment, conducts periodic searches of institutional, university, and healthcare entity sites online for identification and particulars of clinical studies and stores such information in the MSC database. Suitable sites for such searching are described further below along with examples thereof. Information for clinical studies can also be assembled by telephonic or other communications with sponsoring organizations, in which case the information for such clinical studies may be input manually or in an automated manner by exported electronic file(s) from the sponsoring organization(s). Online-received information can also be input manually or using an automated process, although in view of the sensitivity of inclusion/exclusion requirements it is further preferred that any such data entries are double checked to assure accuracy irrespective of manner of inputting said information.

In one embodiment, once a patient selects the Study Participation Module, the module is programmed to select or deselect the patients to a given study, having criteria of selection compared against a patient's medical history and current diagnoses and treatment(s). A patient not yet signed onto the MSC System must enter information for identification and accept assessment of his/her medical information before eligibility is considered, after which inclusion and exclusion criteria are assessed. As contemplated with respect to the patient that is already a user of the MSC System, having input patient medical history, current diagnosis or diagnoses, as appropriate, and maintained currency of patient medical status in the electronic records of the MSC System, selecting the Study Participation module starts a series of queries geared toward identifying a clinical study relevant to the patient's diagnoses. (If the patient has no current diagnoses, or is interested in participating in a clinical study irrespective of his/her diagnosis, then the Study Participation module includes a place to so indicate that the patient is available as a “healthy” participant.)

Once the MSC System's database of clinical studies is queried for relevant clinical studies relative to the patient's interests, a query is undertaken to determine whether or not the patient's identity information and medical history contain any entry that bars participation due to the clinical study's key eligibility requirements, which typically pertain to identity (i.e., gender, age, genotype or ancestral background) and broad areas of medical condition (e.g., healthy or not healthy, certain blood component concentration in normative range, primary versus metastasized cancer, presence/absence of autoimmune disease, history of particular categories of treatment, among others). More particular inclusion criteria must also be satisfied for participation. Inclusion criteria typically pertain to specific entries in one's medical history, such as past diseases, particulars of one's blood chemistry or hematology (e.g., granulocyte and platelet counts, hemoglobin concentration, and the like), current healthy hepatic function, recovery from acute toxicity due to prior therapy, results from imaging studies (showing, e.g,, a clear bone scan or negative CT/MRI scans), willingness to travel to a non-local study site, among other criteria.

Participation in a clinical study may also require that specified exclusion criteria are not part of the patient's medical history. For example, common reasons to exclude a candidate participant may relate to the patient's medical status or history, such as one or more of the following—immunocompromised status; past or current use of certain categories of drugs, such as steroids, that have a systemic effect; serious intercurrent medical illness; history of seizures; use of drugs having potential to interfere with any aspect of the clinical study protocol; recent surgery; history of particular allergic reactions; history of certain skin lesions; necessary contact with individuals at potential risk to any protocol component that may be transmitted inadvertently by the participant; history of hepatits B or C; among others.

Once the patient has been accepted into a clinical study, the Study Participation module continues to assess input information during the study, and flags any candidate or participant if new information indicates that (i) the participant no longer complies with the study requirements, thus causing such participation to cease, or (ii) the candidate now does comply with the study requirements, thus allowing participation to the extent that the study has room for another participant. A sort of issue that can exclude a participant or include a candidate, for example, may relate to a side effect of a class of medication that the participant reported anew after having been accepted into the study, but which side effect then causes cancellation of that participant's inclusion; and, conversely, a candidate having previously reported such a side effect to a class of medication may, at a subsequent point in time have been more refinely tested to learn that s/he is of a genotype that is an exception to the rejection based on the particular side effect, in which case the candidate may be accepted into the study. Other bases for resolving issues raised by a side effect concern may come into play.

Regarding the participant whose new side effect information results in exclusion from the study, in the absence of input that resolves the concerns of the side effect, an alert and communication will be generated to the source (a pharmacy or a drug company, typically) providing the drug for the study to cease sending the drug to the now former participant. Further, the source(s) providing testing will also be alerted to cease providing tests to that now former participant.

The MSC System issues reminders to participants for filling in questionnaires and sending in same at specific times per the study requirements. The MSC System also issues reminders and orders to have certain tests performed, such as blood tests, imaging, and the like, as well as to schedule and attend office visits for clinical evaluations.

Payment in the context of such studies is not necessarily part of any MSC System protocol but, instead, is more typically the responsibility of a sponsor that has commissioned a given study undertaken in the context of the MSC System. Either subjects or physicians or both are commonly paid for participation in such studies. However, a common approach is to have a third party control and make any such payments to participants in a given study.

Researchers will be blinded because the access of MSC System participants provided to them contains only identification numbers. Interim statistical analysis can be done by the researchers who will have access to the non-identified files. Graphs and reports can be generated at any time or at the end of the study using data included in the MSC System.

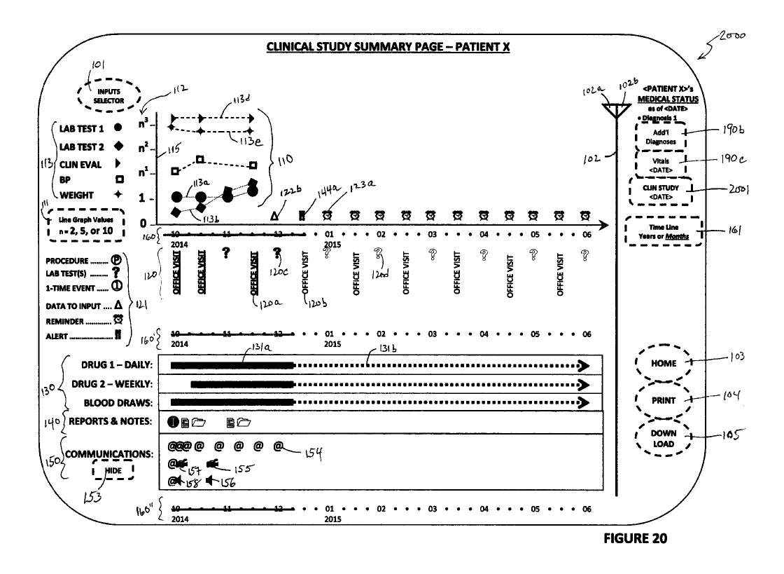

An exemplary summary page 2000 for the data and forward requirements of an individual participant is shown in FIG. 20, which may or may not be made available to the patient per requirements of the clinical study. (Some clinical studies require that participants NOT be apprised of all or certain medical data generated in the study; in that case, the line graph 110 entries can be limited to only those data acceptably shown the patient, or rendered entirely absent; or the entirety of the clinical study summary page can be limited to viewing only by the clinical study organizer(s).) Components of the clinical study summary page 2000 that are common to the MSC System home screen 100 of FIG. 1A are associated with the same numeral and have the same function as described herein; and differ in the clinical study summary page 2000 only to the extent described herein. One particular difference is that the summary page includes a timeline that recites both past as well as future dates thereby clearly setting forth the accomplishment of past and indicators of future events called for by the clinical study's protocol.

Irrespective whether data generated under the study are shared with the patient-participant, the summary page 2000 can be usefully employed for providing reminders 123a for blood draws, office visits, and other components of the study protocol, as well as showing the bar graph 130 for ongoing components of the study. Moreover, the timelines 160, 160′, and 160″ show both past and future time points, wherein past dates can be indicated by a strike-through of the indicated past date(s) or another distinguishing feature. Indicators for other one-time events, such as procedures, lab tests, office visits, and the like, are shown differently between those in the past and accomplished, in the past but missed, and future such events; again, using typographical features to distinguish between the stated categories. Regarding office visits, appointments, in one embodiment, are indicated by the recital of the term “office visit” in the event-recital area 120 along the length of the time line 160 using a regular (non-bold) font; if the appointment was kept, then, like the past dates on the time line, the attended “office visit” is indicated using a strike-through, bold font and the reminder icon 123a for that appointment disappears; and if the appointment was not kept, then the recital of “office visit” remains in the regular (non-bold) font and an alert icon 144a appears in place of the reminder icon 123a for that appointment. Similarly, for lab tests/blood draws indicated by a question mark icon, the question mark icon can be in an outline font for future dates and solid font for past dates; if the lab test/blood draw occurred, then the reminder icon simply disappears at the same time the question mark icon turns from outline font to solid font; and if the lab test/blood draw

Accordingly, the summary page 2000 provides opportunity to show the patient his/her future obligations for the study with reference to office visits, blood draws, or other aspects of the protocol. The same set of icons can be employed on the home screen 100 using the analogous positions as just indicated for the summary page 2000.

A place for communications 150 between the patient-participant and the clinical study organizer or medical professional is also included.

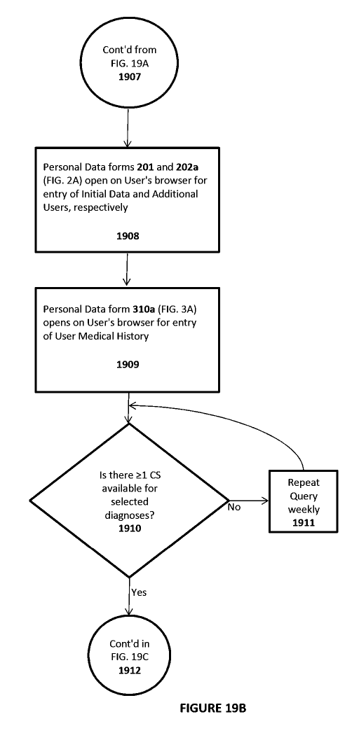

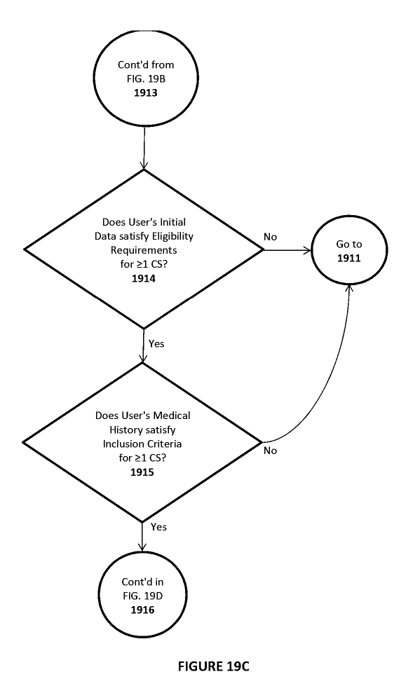

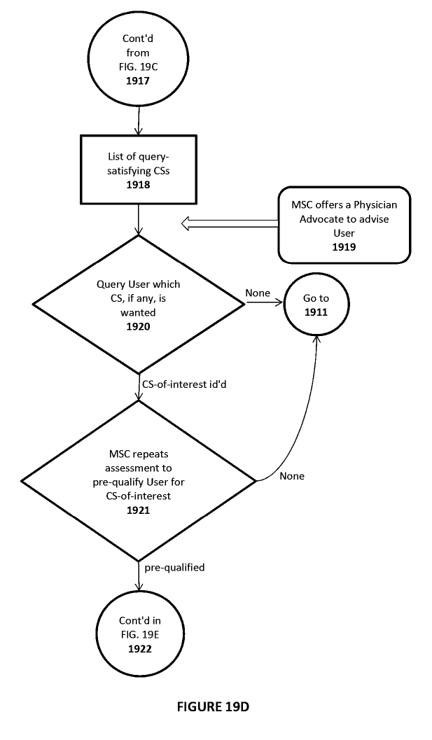

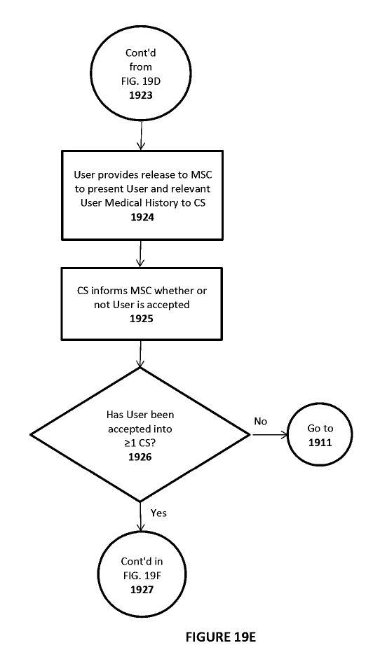

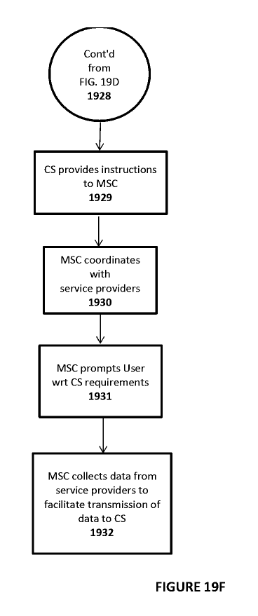

A flow chart of how the MSC System in one embodiment can be usefully employed in the conduct of medical studies is illustrated in FIGS. 19A through 19F, inclusive. For this embodiment, the Study Participation module may be operated independent of the medical-records-keeping functions of the MSC System or as an integral component thereof, as will become apparent in the following discussion. Having indicated the prospect of operating the interactive graphic electronic clinical study management tool of the present invention independent of the MSC System overall, it is nonetheless far more efficient for any prospective participant of a clinical study to avail him- or herself of the MSC System for keeping his/her medical records, thereby minimizing inapt identifications of clinical studies relative to requirements of inclusion in such studies. Accordingly, the interactive graphic electronic clinical study management tool has a predisposition to use aspects of the MSC System for recording medical data and identity information of any prospective clinical study participant, as will be seen in the following discussion of the illustrated sequence of steps shown in FIGS. 19. (Note: Steps 1906-1907, 1912-1913, 1916-1917, 1922-1923, and 1927-1928 refer, respectively, to the continuation points between FIGS. 19A to 19B, 19B to 19C, 19C to 19D, 19D to 19E, and 19E to 19F.)

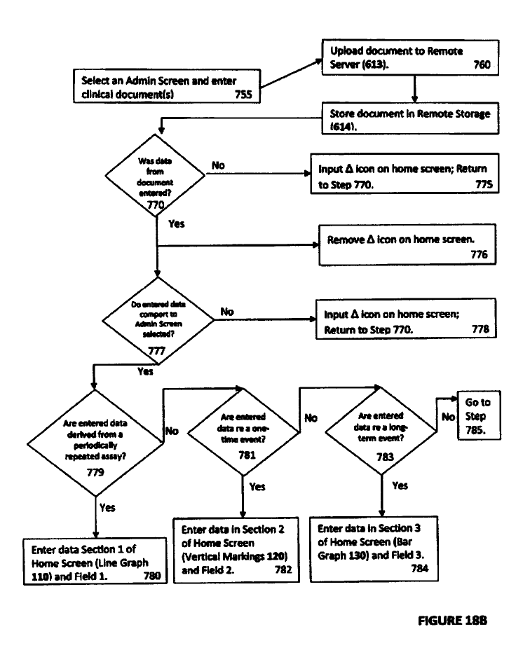

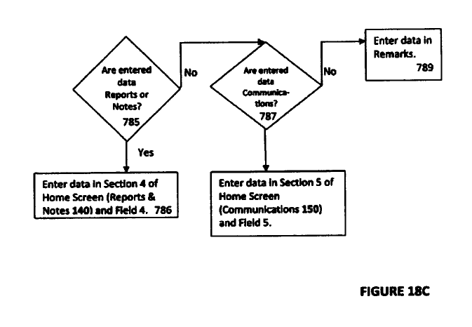

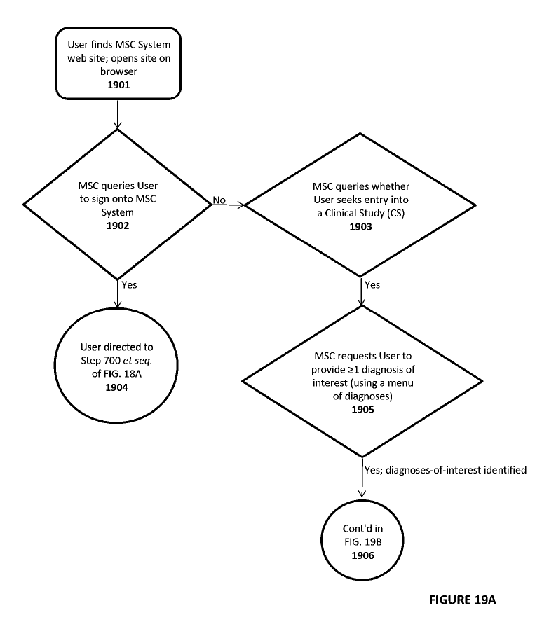

An individual (generically referred to as a “User”) seeking information from internet websites about clinical studies, identifies the MSC System as a source of information regarding same, seeks out the MSC website and opens that site on the user's computer or handheld device using a standard browser (Step 1901). The MSC website queries the User whether s/he is interested in entering and keeping her/his medical data on the MSC System (Step 1902). If so, the User is referred to Step 700 et seq. as set forth in FIG. 18A (Step 1904), which is discussed in detail herein below. The User in seeking out information regarding clinical studies may, of course, be seeking information for him- or herself, or may be doing so for the benefit of another individual. Either way, if the user responds positively that there is interest in using the MSC System for keeping his/her medical records, then the user is directed to Step 700 et seq. as shown on FIGS. 18A, 18B, and 18C. Step 1904.

If, however, the User indicates that s/he is not interested in entering and keeping medical data on the MSC System, the MSC website then queries the User's interest in seeking entry into a clinical study (“CS”) (Step 1903). Users having such interest are referred to herein as a prospective study participant (“PSP”). Typically, at this point if the User is seeking the information for a PSP, operation of the module protocol is turned over to the PSP—unless, of course, the User is guardian or otherwise sufficiently close in relationship and knowledge to proceed and answer the proffered queries regarding intention and medical data.

Accordingly, if the User asserts interest in seeking further information regarding available clinical studies, studies, then the MSC website further requests recital of one or more personal diagnoses for which the PSP is seeking a clinical trial (Step 1905). The MSC website can use open forms for entry of typed-in answers or a dropdown menu of medical diagnoses. The dropdown menu can facilitate the identification of the diagnosis or diagnoses of interest by first asking which tissue or system of the body is afflicted and then providing a listing of diagnoses appropriate to the selected tissue or system. Too, the PSP may be healthy and is seeking entry into a clinical study that uses healthy participants; in which case the drop-down menu may include an entry for a not-diagnosed candidate participant.

Another necessary entry of information for the PSP regards certain of the individual's personal information, for which appropriate data entry forms are opened on the website for receiving certain information and physical characteristics of the PSP, namely name, gender, age, height, weight, and address (collectively referred to as Initial Data) (Step 1908); the gender, age, height and weight data can be entered into an open form or by use of drop down menus; preferably, as exemplified for the instant embodiment, the personal data form presented on the website appears as form 201 as included in FIG. 2A.As noted above, this information is necessary for screening prospective clinical studies for the PSP, noting that broad considerations of age, gender, weight-to-height ratios, even location can be dispositive whether or not a candidate will be considered for entry into a given study.

The MSC website will also ask the PSP to enter the identity of other individuals who either may have access to the PSP's account, whether to be able to view it and/or make entries. Such other individuals, referred to here as additional users, can be the PSP's relative or friend, or his/her physician or other advisor for such medical-related concerns. This information can be entered in an open form presented at the MSC website; preferably, per the instant embodiment, the form used is as set forth as form 202a of FIG. 2A hereof Step 1908. Of course, the PSP may elect to enter no additional user, in which case form 202a or a data entry form re such information is left blank.

The MSC website next presents a personal data form for the PSP to provide his/her medical history. Preferably, the form used is or approximates personal data form 310a as illustrated in FIG. 3A hereof Step 1909. These data are required to satisfy the inclusion requirements as well as the exclusion requirements for a given clinical study. Such qualifying requirements are specified by the organizer(s) of the clinical trial, and may be assessed by the organizers or by the MSC System. As indicated in the protocol set forth in FIG. 19, the MSC System does the prequalifying assessment and thus is in position to deliver to the organizer(s) of the clinical study pre-qualified PSPs. Either way, the MSC requests and the PSP provides the necessary medical history data (Step 1909).

The most efficient manner for assembling the medical history is for the PSP to have availed him- or herself of the MSC System as set forth herein for keeping his/her medical records. In the absence of having done so previously, the PSP is invited to partake of the MSC System medical records-keeping functions, directing him or her to Step 700 et seq. of FIG. 18A. If the PSP continues to eschew joining the MSC System overall, then data entry forms are provided online for entry of his/her medical history as indicated above. If the PSP objects to providing all of his/her medical history, then a subset thereof specific to the requisite pre-qualifying medical data for specified clinical studies is provided on the MSC website (forms not shown, specific to a given diagnosis and requirements of the organizer(s) of the clinical trial).

Having been provided at least one personal diagnosis of interest, the MSC System queries its own database of clinical trials that are then enlisting participants (Step 1910). The MSC database is populated with information regarding the target subject and participant requirements for clinical trials scheduled and run by organizations as well as individual physicians that have been received. The MSC database is also populated with such information from governmental agencies (both U.S. and foreign), university or other research institutions, hospitals, corporations, compilers of such information, and other sources of clinical trial information, such as, without limitation intended, www.clinicaltrials.gov, us.testwiththebest.com, www.cancer.gov/clinicaltrials, the National Institutes of Health (U.S.; www.nih.gov/health/clinicaltrials/), www.centerwatch.com/clinical-trials, www.clinicaltrials.com, University of Chicago (www.uchospitals.edu/clinical-trials/index.html and cancer.uchicago.edu/trials/), Stanford University (med.stanford.edu/clinicaltrials), The Mayo Clinic (www.mayo.edu/research/clinical-trials), www.asbestos.com/treatment/clinical-trials.php, Sloan-Ketering Cancer Center (www.mskcc.org/cancer-care/clinical-trials), Massachusetts General Hospital et al. (i.e., MGH, BWH, and others; clinicaltrials.partners.org), Northshore University Healthsystem (www.northshore.org/research/clinical-trials), and the like.

If querying the MSC database of information relating to clinical studies targeting the diagnoses of interest (Step 1910) reveals no available clinical studies, then the query is set to be repeated weekly for that PSP (Step 1911). If there is at least one clinical study identified with respect to the diagnoses of interest, then the so-identified clinical study or studies are screened with respect to the Initial Data of the PSP and the various clinical studies' eligibility requirements. Step 1914. If the PSP is disqualified from participating in all of the identified clinical trials due to requirements not met by the PSP's Initial Data (pursuant to Step 1914), then the query to identify suitable clinical studies is repeated weekly (Step 1911), and the process starts anew.

But if there is at least one clinical trial identified that would provisionally accept the PSP based on his/her Initial Data (Step 1914), then the process procedes by next asking whether the PSP's medical history satisfies the inclusion criteria for at least one clinical study relevant to the interests of the PSP. Step 1915. If not, then, once again, the query to identify suitable clinical studies is repeated weekly (Step 1911), and the process starts anew. But if so, then those clinical studies of interest to the PSP for which the PSP had not entered any personal or medical information that contraindicated inclusion in the clinical studies are presented to the PSP as a list. Step 1918. The MSC System, at least by this point, offers a Physician Advocate to advise the PSP (Step 1919). The Physician Advocate has suitable training in medicine and the area of the PSP's personal diagnosis to understand the requirements of the clinical trial and its design and uses that knowledge to advise the PSP on what is involved in the trial. Among concerns of the PSP are issues relating to likelihood of being in an untreated, possibly placebo-administered control group, timing and degree of invasiveness of clinical evaluations and lab testings, and the like. The physical location of the study can be an important factor as well. Indeed, even if most of the requirements for the study can be administered to the patient at a location local to his/her residence, there may still be requirement for travel to the headquarters for the clinical study, such as a department of the National Institutes of Health in Bethesda, MD. If the answer to Step 1920 is not to any of the identified clinical trials, then, once again, the request of this PSP returns to the earlier inquiry for available clinical trials on a weekly basis (Step 1911). But is Step 1920 results in at least one identified clinical study of interest that the PSP accepts, then the process proceeds further.

At this point, in the embodiment illustrated in FIG. 19, the MSC System repeats the assessment of inclusion and exclusion requirements for the clinical study of interest, updating its database of such requirements, and subjects the PSP's personal and medical data to further scrutiny. Step 1921. If the repeated assessment indicates that there are no clinical studies that the PSP can qualify, then the next step is to return to Step 1911 and repeat the initial query to find prospective clinical studies on a weekly basis.

But if Step 1921 results in the PSP being prequalified for at least one clinical trial, then the PSP is requested to provide release affirmatively to the MSC System to present the PSP and his/her relevant personal and medical information to the organizer(s) of the appropriate clinical trial(s) (Step 1924). The organizer(s) may or may not make direct contact with the PSP; and they may or may not elect to involve the MSC System in downstream communications between it or them and the PSP. But, referencing the embodiment set forth in FIG. 19, the clinical study organizer(s) will, at minimum, inform the MSC System whether or not the PSP has been accepted into its or their clinical trial(s). Step 1925. If the PSP is accepted by none of the organizers of the clinical trial(s) (Step 1926), then, once again, the PSP's request for participation in a clinical trial is repeated weekly (Step 1911).

For those embodiments of the Study Participation Module where the clinical study organizer elects to involve the MSC System further in managing participants, or at least those participants provided by the MSC System, the organizer provides instructions to the MSC System or to both the PSP and the MSC System (Step 1929). Such instructions may include the course of treatment scheduled for the PSP, source(s) of medication, location(s) of clinical treatments or evaluations, laboratory tests, timings therefor, and the like. Pursuant to the organizer's instructions, the MSC System coordinates efforts with any named third party service or drug provider included among the medication and clinical service providers (Step 1930). The MSC System also is set to prompt the PSP with respect to requirements for the clinical study including, without limitation intended, reminding the PSP to take prescribed medication, make and keep appointments for clinical treatments or evaluations and blood draws or other tissue samplings; and provide other specimen samples, as appropriate (Step 1931). The MSC System can also contact and collect from third party organizations involved in the collection and/or analysis of samples or data to facilitate transmission of data to the organizer(s) of the clinical study (Step 1932).

The MSC System can employ a clinical study summary page specific to a given patient, available online among other avenues, that captures the various elements noted above in the described embodiment for the Study Participation Module. One embodiment of the clinical study summary page is illustrated in FIG. 20. All elements that appear in both the home page for the MSC chart (FIG. 1A) and the clinical summary page operate as described for the MSC chart unless otherwise described here. An important distinction between the As shown, lab test results or other periodically-arising data are displayed in the line graph 110. To exemplify this feature, FIG. 20 shows two lab test results along the lines having solid diamond-shaped data points 113b and solid circle data points 113a. FIG. 20 also shows results of periodic clinical evaluations using a dash line 113d, where the data points are indicated by right-oriented solid arrow heads. It is not suggested that clinical evaluations would necessarily be shared with the patient while in the midst of the clinical study as such evaluations may relate to pain level, tumor load, or some other clinical observation that, were it to remain flat could be interpreted to mean that the patient was taking either an ineffective drug or a placebo. No PSP would know whether or not s/he was included in the control or experimental group, however, nor would her or his physician, so it is not appropriate for those data to be shared until after the study has ended or the organizer(s) decide that all participants should receive the active ingredient.

The clinical study summary page, however, can be employed to record the patient's vitals recorded at each office visit. For example, it may be important to track the patient's weight over the course of the study, for which the star-shaped data point-containing line 113e on the line graph 110 is intended. Of course, one can also keep track of blood pressures as well, as indicated for line 113f.

A further description of variances between the forms and drop menus found among the MSC System screens associated with the various Modules is further described below, after first describing the various admin screens.

From the Registration screen, one can readily print or download the entered information by clicking on the Print button 102 or the Download button 105, as appropriate; alternatively, one can return to the home screen by clicking the Home button 103. One can also click on one of the horizontal set of hyperlink buttons 170 to select an appropriate admin screen and there upload any document as well as enter its contained information for cataloguing in the MSC System.

A common next step in beginning use of the MSC System involves inputting clinical data learned from one's physician or from copies of medical records in the possession of the patient. Implementing a second signal on the “Clinical Data” button 170a of the horizontal set of admin screen buttons 170 will cause the “Clinical Data” admin screen to appear on the user's computer display. In the absence of having selected a module for any practice area on the Module Options screen 210 (FIG. 2B), the clinical data screen 300 that arises upon clicking the Clinical Data button 170a is illustrated in FIG. 3A, which is designed to record the patient's clinical data that is relevant to any medical condition. Recorded on that screen 300, in section 310, are data relating to the patient's height, weight, blood pressure, resting pulse, temperature, allergies (if any), medications, infectious disease history, medical illness history, vaccination history, marital status, employment, and the age and health of the patient's children. Each item of these data is recorded as of the date observed or entered, for which a column 312 is provided that is labeled “Date”; and remarks to expand upon the data are provided in a separate column 313 as well, if appropriate. The entry of allergies, medications, and histories of infectious diseases, medical illnesses, and vaccinations are entered using respective drop menus 314 on which are organized prevalent such illnesses, conditions, and treatments, along with an ability to choose “other” if not listed. For the “other” illness, condition, or treatment, the name of thereof is recited by typing in the appropriate word(s) in the box adjacent the given drop menu.

The clinical data screen 300 also includes a place 311 for entry of a full medical history and physician's report from a physical examination, which can be entered by scanning hard copies of the full medical history and physical exam report or, if these documents were provided to the patient in digital form, by entry of the appropriate files. These entries are accomplished by clicking on the “Select Form or Upload Data” button found in section 311, whereupon a pop-up screen appears for selecting a form for entry of medical history or physical exam results (not shown); and, as a next step, in the instance that the patient was in possession of the appropriate documents, selecting the file(s) containing the full medical history and/or physical exam report provided by the patient's current or prior physician, and then clicking on the “Upload” button (not shown) in an area adjacent the area for selecting said file or files. Alternatively, in the instance that the patient did not have appropriate documents provided by his/her physician, the patient can download a blank form for a medical history or recording results from a physical examination and either fill it in directly and upload or provide to his/her physician for filling out and then uploading such documents into the MSC System at section 311.

The Clinical admin screen also includes a section 317 where clinical articles and other medical-oriented references are listed and accessible for download by the user. The references available at section 317 are generally listed in order of likely interest to the user based on data entered into the MSC System. Accordingly, a user whose clinical data includes recital of a diagnosis of diabetes, for example, may find references listed in section 317 that present approaches for managing one's diet, measuring blood sugar levels, adjusting diet and/or insulin injections with respect to levels of activity, and the like. Similarly, a user whose Clinical admin screen recorded troubling issues concerning the user's current employment and/or health of a child may find references listed that address approaches for managing stress and, perhaps, a job search. The user is also able to enter references into section 317 via the same mechanism for uploading clinical files discussed above, using the mechanism provided by section 315. Such uploaded references are automatically catalogued in and associated with the MSC System library; however, the user who enters a particular reference is free to delete it via clicking the “Delete File” button located at section 317.

Specialized clinical admin screens are available for the different modules that may be indicated in completing the Registration process. Accordingly, for a patient who has a diagnosed prostate cancer, for example, the clinical admin screen shown in FIG. 3B provides entry fields for collecting prostate-specific information. As listed in section 310b, additional information fields for entering information for the prostate cancer patient include prostate volume, Gleeson score, ploidy of the prostate cancer cells, prostate-specific antigen (PSA) level upon diagnosis, PSA density, and prostate gland volume. Also recited on this clinical admin screen, in section 310c, is the clinical stage. Two tools useful in analysis of the prostate-directed data is a Partin Table and a PSADT Calculator, which can be accessed by clicking on hot buttons 320 and 321, respectively. Upon such clicking, access is made to an internet site that provides such tools, which then appear on the user's computer screen. In all other respects, the specialized clinical admin screen for prostate cancer patients is the same as the clinical admin screen for patients who select no specialized module.

Another specialized clinical admin screen is shown in FIG. 3C, which is designed for female patients seeing a gynecologist. Accordingly, section 310c includes entry fields for chief complaint, parity, last menstrual period, previous gynecological surgery, a query whether DES was used by parents, last PAP smear, a query regarding current sexual activity, number of sexual partners, whether there has been a new sexual partner within the last three months, whether the patient required her male sexual partners to use a condom, whether the patient used contraceptives and by what method(s), whether there is a history of sexual abuse, a system review, and assessment whether the patient is post- or peri-menopausal. In all other respects, the specialized clinical admin screen for gynecological patients is the same as the clinical admin screen for patients who select no specialized module.

As noted above, there are a number of different admin screens designed for downloading support documents and entry of data, which will be addressed now. All admin screens include each of the following, which work and appear the same on each admin screen, as follows:
A section 420 that provides tools for uploading documents to the MSC System. If the document intended for upload is a support document for data entered or to be entered, then check box 212 is marked, and left unmarked if the document does not support any data entered or to be entered; a file containing the document is identified via the identifier function of button 211; and the identified file is uploaded to the MSC System by way of the Save Input button 213. To upload additional documents, the Next button 215 is clicked upon.
A horizontally-disposed set of hyperlinked buttons 170a to 170n, inclusive, for selecting and having appear on one's display an admin screen for entering or editing data and uploading, downloading, or deleting a document.
A vertically-disposed set of hyperlinked buttons 180a to 180n, inclusive, for selecting and having appear on one's display a report of patient-specific information, a selector or reviewer of modules, resources, and records.
A Home button 103 for returning to the home screen.
A Print button 104 for printing the currently displayed screen.
A Download button 105 for downloading the currently displayed screen.
A Table 430 of prior data entries of the group identified by the selected admin page. The included column headings of the tables for the respective admin screens are substantially the same, but some do vary.

First, FIG. 4 illustrates one embodiment of the Diagnosis admin screen 400, which arises upon contacting the Diagnoses/Allergies button 170b with a first signal, i.e., a left-click of a computer mouse, for example. The Diagnosis admin screen 400 includes section 410 for recital of the name of a given diagnosis, date of the diagnosis, and remarks. The diagnosis can be of a disease or a condition, such as an allergy, which diagnosis is selected from entries found on a drop menu at subsection 412. If none of the listed diseases and conditions of the drop menu match the patient's diagnosis, then “other” is selected from the drop menu and the name of the disease or condition is entered in adjacent sub-section 414. The date of the diagnosis is entered in subsection 416; however, if the disease or condition has resolved, then a check box 417 included in the area of subsection 416 for date entry is checked and the date entered is the date of resolution of the diagnosis. The user may also enter remarks in the appropriate area of subsection 418 and if the remarks so entered are appropriately included in a Note to be catalogued in the MSC System, then the check box 418a is marked. The remarks entered in subsection 418 can also be used as explanation for an alert due to some result or event of the past selected for the user to be mindful of, for which the double-exclamation point icon is to be included on the home screen, in which case the check box 418b is marked; alternatively, the remarks may be used as a reminder for a future act, where a reminder icon (an “alarm clock” sketch or cartoon [symbol] per the illustrated embodiment of the figures) appears on the home screen, and, for that purpose, the check box 418c is marked. The user may also think it appropriate that his/her remarks input into section 418 ought to be emailed to someone, in which case the ampersand icon 419 is clicked upon and the language already input into section 418 appear in the message portion of an email composition screen.

The Diagnosis admin screen 400, like all admin screens, also includes a section 430 for a listing of all support documents relating to diagnosis issues for the patient. If the user had right-clicked (i.e., contacted with a second signal) on a capital delta Δ icon that was placed on the x-axis 114 due to the data of a diagnostics test report, for example, having not been entered as yet, then Diagnostics Admin Screen would appear and the line of information relating to the support document would appear highlighted in the Table of Prior Diagnoses/Allergies Data located in section 430 of admin screen 400.

This Table of Prior Diagnoses/Allergies Data presented in section 430 is a Group Data Report of just the support documents relating to the diagnosed conditions, diseases, or allergies included in the MSC System for the particular patient. The items included in this group data report are: the Name of the diagnosed condition, disease or allergy (column 431); the date that the condition, disease or allergy began (column 433); the date that the condition, disease or allergy ended (column 434); remarks (column 441); a hot button to be clicked upon in order to view the support document (column 442); a hot button to be clicked upon in order to edit entries made on the admin page with respect to a particular support document (column 443); a hot button to be clicked upon for uploading a document (column 444); a hot button to be clicked upon for downloading the support document indicated in the line of the group data report (column 445); and a hot button for deleting the entries made with respect to a particular support document and the line of the group data report (column 446).

When a Group Data Report is created in response to clicking on the Group Data hot button 180b, then all lines of the resulting group data report include all columns even though some columns will be blank depending on the group to which the supporting document pertains. In addition to the columns indicated above with respect to the supporting documents relating to diagnoses and allergies, starting after column 434 are the following additional columns: treatment applied (column 435); dose of medication (where the treatment is the administration of a medicinal agent) (column 436); frequency of administration of the medicinal agent (column 437); orders, if any (column 438); side effects of the procedure or treatment (column 439); and recital of the subject to which the line refers (column 440).

Turning now to FIG. 5 in which one embodiment of an admin screen for a lab test is presented and which arises upon clicking on the Lab Tests hot button 170c with a first signal, i.e., a left-click of a computer mouse, for example. The Lab Tests admin screen 500 includes section 510 for recital of the name of a given lab test, which can be selected from a drop menu 512 or, if the particular lab test is not listed in the drop menu, then one would select “other” in the menu and then recite the name of the lab test in subsection 514. One further inputs the value of the lab test in subsection 516. For example, in the instance of a cholesterol blood test, the concentration in the blood of a given fraction of cholesterol can be entered. Importantly, one also enters the date in subsection 518 that the blood was drawn (or other subject tissue sampled) for the lab test. Upon review of a lab test, one's physician not uncommonly will then issue an order for a follow-up test, or office visit, or procedure, which order is noted by checking box 520a and selecting the order from drop menu 520. Alternatively, one's physician or oneself can have a request for further information or explanation with regard to history or prognosis or the like upon seeing results of a given lab test, in which case box 520b is checked and the drop menu 520 presents standard such requests. Such a request can be expanded upon by issuing a note in the subsection labeled Remarks, checking box 530a. In that case, the user enters remarks in the appropriate area of subsection 530 and if the remarks so entered are appropriately included in a Note to be catalogued in the MSC System, then the check box 530a is marked. The remarks entered in subsection 530 can also be used as explanation for an alert due to some result or event of the past selected for the user to be mindful of, for which the double-exclamation point icon is to be included on the home screen, in which case the check box 530b is marked; alternatively, the remarks may be used as a reminder for a future act, where a reminder icon (an “alarm clock” sketch or cartoon [symbol] per the illustrated embodiment of the figures) appears on the home screen, and, for that purpose, the check box 530c is marked. The user may also think it appropriate that his/her remarks input into section 530 ought to be emailed to someone, in which case the ampersand icon 532 is clicked upon and the language already input into section 530 appear in the message portion of an email composition screen.

Particularly useful with respect to lab tests, among other categories of information included in the MSC System, one can specify a date range using hot button 545 and then select hot button 540 to generate a graph of the data available for the particular lab test within the given range of dates.

A similar block of data and inputs can be input using the Diagnostic Test admin screen as illustrated in FIG. 6. This screen arises upon clicking hot button 170d with a first signal, i.e., a left-click of a computer mouse, for example. The Diagnostic Test admin screen 600 includes section 610 for recital of the name of a given diagnostic test, which can be selected from a drop menu 612 or, if the particular diagnostic test is not listed in the drop menu, then one would select “other” in the menu and then recite the name of the diagnostic test in subsection 614. One further inputs the value of the diagnostic test in subsection 616. For example, in the instance of an immunological test for identifying antibodies in one's blood for one of the various known hepatitis viruses, one can enter positive, negative, or inconclusive for the result. Importantly, one also enters the date in subsection 618 that the blood was drawn (or other subject tissue sampled) for the lab test. Upon review of a diagnostic test, one's physician not uncommonly will then issue an order for a follow-up test, or office visit, or procedure, which order is noted by checking box 620a and selecting the order from drop menu 620. Alternatively, one's physician or oneself can have a request for further information or explanation with regard to history or prognosis or the like upon seeing results of a given lab test, in which case box 620b is checked and the drop menu 620 presents standard such requests. Such a request can be expanded upon by issuing a note in the subsection labeled Remarks, checking box 630a. In that case, the user enters remarks in the appropriate area of subsection 630 and if the remarks so entered are appropriately included in a Note to be catalogued in the MSC System, then the check box 630a is marked. The remarks entered in subsection 630 can also be used as explanation for an alert due to some result or event of the past selected for the user to be mindful of, for which the double-exclamation point icon is to be included on the home screen, in which case the check box 630b is marked; alternatively, the remarks may be used as a reminder for a future act, where a reminder icon (an “alarm clock” sketch or cartoon [symbol] per the illustrated embodiment of the figures) appears on the home screen, and, for that purpose, the check box 630c is marked. The user may also think it appropriate that his/her remarks input into section 630 ought to be emailed to someone, in which case the ampersand icon 632 is clicked upon and the language already input into section 630 appear in the message portion of an email composition screen.

One embodiment of the admin screen for entering information relating to procedures is provided in FIG. 7. Without intending to limit the range of alternative procedures that may be recorded using the Procedures admin screen, procedures include any of the following: a surgery, irrespective whether on an outpatient or hospital-admitted basis, including, for example, radical prostatectomy, cholecystectomy, mastectomy, coronary artery bypass; a course of physical therapy; a course of occupational therapy; a course of speech therapy; and the like.

This admin screen arises in response to clicking on input selector menu on button 170e with a first signal, i.e., a left-click of a computer mouse, for example. The Procedures admin screen 700 includes section 710 for recital of the name of a given procedure, which can be selected from drop menu 712 or, if the particular procedure is not listed in the drop menu, then one can alternatively select “other” in the menu and then recite the name of the procedure in subsection 714. As a procedure may be a one-time event or part of a long-term event, importantly, one also enters the starting date in subsection 716 and, if and when appropriate, the ending date in subsection 718. Similar to the aforementioned admin screens, upon review of a lab test, one's physician not uncommonly will then issue an order for a follow-up test, or office visit, or additional procedure, which order is noted by checking box 720a and selecting the order from drop menu 720.

Alternatively, one's physician or oneself can have a request for further information or explanation with regard to history or prognosis or the like upon seeing reviewing information concerning the procedure, in which case box 720b is checked and the drop menu 720 presents standard such requests. Such a request can be expanded upon by issuing a note in the subsection labeled Remarks 730, and checking box 730a. In that case, the user enters remarks in the appropriate area of subsection 730 and if the remarks so entered are appropriately included in a Note to be catalogued in the MSC System, then the check box 730a is marked. The remarks entered in subsection 730 can also be used as explanation for an alert due to some result or event of the past selected for the user to be mindful of, for which the double-exclamation point icon is to be included on the home screen, in which case the check box 730b is marked; alternatively, the remarks may be used as a reminder for a future act, where a reminder icon (an “alarm clock” sketch or cartoon [symbol] per the illustrated embodiment of the figures) appears on the home screen, and, for that purpose, the check box 730c is marked. The user may also think it appropriate that his/her remarks input into section 730 ought to be emailed to someone, in which case the ampersand icon 732 is clicked upon and the language already input into section 730 appear in the message portion of an email composition screen. All other aspects of the Procedures admin screen conform to those of the other admin screens.

One embodiment of the admin screen for entering information relating to events is provided in FIG. 8. Without intending to limit the range of alternative events, whether one-time events or long-term events, that may be recorded using the Events admin screen, events include any of the following: office visit, death of family member, divorce, job loss, car accident, hospitalization over period of time, rehabilitation over period of time, bed ridden over period of time, and the like.

This admin screen arises in response to clicking on the input selector menu (button 1701) with a first signal, i.e., a left-click of a computer mouse, for example. The Events admin screen 800 includes section 810 for recital of the name of a given event, which can be selected from drop menu 812 or, if the particular event is not listed in the drop menu, then one can alternatively select “other” in the menu and then recite the name of the event in subsection 814. As an event may be a one-time event or a long-term event, importantly, one also enters the date in subsection 816, which date may be the only date entered, indicating that the event is a one-time event, or it may indeed by the starting date for a long-term event. Accordingly, if indeed the event is a long-term event, an ending date will be entered when appropriate in subsection 818. Similar to the aforementioned admin screens, upon review of an event, one's physician not uncommonly will then issue an order for a test, or office visit, or procedure, which order is noted by checking box 820a and entering the order in subsection 820. Such an order can be expanded upon by issuing a note in the subsection labeled Remarks 830, and checking box 830a. In that case, the user (irrespective whether patient or physician, for example) enters remarks in the appropriate area of subsection 830 and if the remarks so entered are appropriately included in a Note to be catalogued in the MSC System, then the check box 830a is marked. The remarks entered in subsection 830 can also be used as explanation for an alert due to some event of the past selected for the user to be mindful of, for which the double-exclamation point icon is to be included on the home screen, in which case the check box 830b is marked; alternatively, the remarks may be used as a reminder for a future act, where a reminder icon (an “alarm clock” sketch or cartoon [symbol] per the illustrated embodiment of the figures) appears on the home screen, and, for that purpose, the check box 830c is marked. The user may also think it appropriate that his/her remarks input into section 830 ought to be emailed to someone, in which case the ampersand icon 832 is clicked upon and the language already input into section 830 appear in the message portion of an email composition screen. All other aspects of the Events admin screen conform to those of the other admin screens.

An embodiment of the admin screen for entering information relating to side effects of a treatment or procedure, for example, is provided in FIG. 9. Without intending to limit the range of alternative side effects that may be recorded using the Side Effects admin screen, side effects include any of the following: a rash or inflammation or other allergic reaction; incontinence due to surgery; impotence due to surgery; paralysis due to trauma; headache; gastrointestinal distress; numbness; loss of consciousness; extreme fatigue; an allergic reaction to a medication, incontinence due to surgery, impotence due to surgery, paralysis due to trauma, and the like.

This admin screen arises in response to clicking on the input selector menu (button 170j) with a first signal, i.e., a left-click of a computer mouse, for example. The Side Effects admin screen 900 includes section 910 for recital the identifier for a given side effect, which can be selected from drop menu 912a or, if the particular side effect is not listed in the drop menu, then one can alternatively select “other” in the menu and then recite the name of the side effect in subsection 914. Also to be entered into subsection 912 is the identifier for the medication or procedure that (at least) appears to be causally related to the symptom(s) associated with the side effect. The so-identified medication or procedure is selected from drop menu 912b unless the particular medication or procedure is not included on the drop menu; in that event, one can alternatively select “other” in the drop menu and then recite the name of the medication or procedure in subsection 914, below the location of the drop menu 912b. As a side effect may be a one-time event or last to become a long-term event, importantly, one also enters the starting date in subsection 916 and, if and when appropriate, the ending date in subsection 918. Similar to the aforementioned admin screens, upon review of a lab test, one's physician not uncommonly will then issue an order for a follow-up test, or office visit, or additional procedure, which order is noted by checking box 920a and selecting the order from drop menu 920. Alternatively, one's physician or oneself can have a request for further information or explanation with regard to history or prognosis or the like upon reviewing information concerning the side effect, in which case box 920b is checked and the drop menu 920 presents standard such requests. Such a request can be expanded upon by issuing a note in the subsection labeled Remarks 930, and checking box 930a. In that case, the user enters remarks in the appropriate area of subsection 930 and if the remarks so entered are appropriately included in a Note to be catalogued in the MSC System, then the check box 930a is marked. The remarks entered in subsection 930 can also be used as explanation for an alert due to some result or event of the past selected for the user to be mindful of, for which the double-exclamation point icon is to be included on the home screen, in which case the check box 930b is marked; alternatively, the remarks may be used as a reminder for a future act, where a reminder icon (an “alarm clock” sketch or cartoon [symbol] per the illustrated embodiment of the figures) appears on the home screen, and, for that purpose, the check box 930c is marked. The user may also think it appropriate that his/her remarks input into section 930 ought to be emailed to someone, in which case the ampersand icon 932 is clicked upon and the language already input into section 930 appear in the message portion of an email composition screen. All other aspects of the Side Effects admin screen conform to those of the other admin screens.

An embodiment of the admin screen for entering orders or requests is provided in FIG. 10. Without intending to limit the range of alternative orders or requests that may be recorded using the Orders/Requests admin screen, orders and requests include any of the following: a prescription for a medication or a blood test or a urinalysis or a surgery or a biopsy with pathological analysis of the excised tissue or a physical therapy or a specific diet; among a plethora of other possible orders.

This admin screen arises in response to clicking on input selector button 170h with a first signal, i.e., a left-click of a computer mouse, for example. The Orders/Requests admin screen 1000 includes section 1010 for recital of the name for a given order and section 1018 for recital of a given request. The order is commonly selected from drop menu 1012 or, if the particular order is not listed in the drop menu, then one can alternatively select “other” in the menu and then recite the name of the order in subsection 1014. Importantly, one also enters the date of the order or request in subsection 1016. The order can be explained or otherwise expanded upon by issuing a note in the subsection labeled Remarks or Order Details 1030. In that case, the user enters remarks in the appropriate area of subsection 1030 and if the remarks so entered are appropriately included in a Note to be catalogued in the MSC System, then the check box 1030a is marked. The remarks entered in subsection 1030 can also be used as explanation for an alert due to some result or event of the past selected for the user to be mindful of, for which the double-exclamation point icon is to be included on the home screen, in which case the check box 1030b is marked; alternatively, the remarks may be used as a reminder for a future act, where a reminder icon (an “alarm clock” sketch or cartoon [symbol] per the illustrated embodiment of the figures) appears on the home screen, and, for that purpose, the check box 1030c is marked. The user may also think it appropriate that his/her remarks input into section 1030 ought to be emailed to someone, in which case the ampersand icon 1032 is clicked upon and the language already input into section 1030 appear in the message portion of an email composition screen. All other aspects of the Orders/Requests admin screen conform to those of the other admin screens.

An embodiment of the admin screen for entering reports or notes is provided in FIG. 11. Without intending to limit the range of alternative reports or notes that may be recorded using the Reports/Notes admin screen, such reports and notes include any comment rendered by patient or service provider. Any text typed or written will be included in this admin page, including, for example, reports based on consultation notes from a specialist or a referral letter to a specialist or an office visit note describing symptoms or findings, assessment and plan (known generally as “SOAP” notes)._Reports may also include results of a biopsy or imaging tests.

This admin screen arises in response to clicking on inputs selector (101) menu button 170i with a first signal, i.e., a left-click of a computer mouse, for example. The Reports/Notes admin screen 1100 includes section 1110 for recital of the name for a given report or note, for which the appropriate box is checked. The report is commonly selected from drop menu 1112a or, if the particular report is not listed in the drop menu, then one can alternatively select “other” in the menu and then recite the name of the report in subsection 1114. The note is named in subsection 1114. Importantly, one also enters the date of the order or request in subsection 1116. The order or note can be explained or otherwise expanded upon by adding remarks in the subsection labeled Remarks 1130. In that case, the user enters remarks in the appropriate area of subsection 1130 and if the remarks so entered are appropriately used as explanation for an alert due to some result or event of the past selected for the user to be mindful of, the double-exclamation point icon is included on the home screen and the check box 1130a is marked; alternatively, the remarks may be used as a reminder for a future act, where a reminder icon (an “alarm clock” sketch or cartoon [symbol] per the illustrated embodiment of the figures) appears on the home screen, and, for that purpose, the check box 1130b is marked. The user may also think it appropriate that his/her remarks input into section 1130 ought to be emailed to someone, in which case the ampersand icon 1132 is clicked upon and the language already input into section 1130 appear in the message portion of an email composition screen. All other aspects of the Reports/Notes admin screen conform to those of the other admin screens.

An embodiment of the admin screen for entering medications or supplements is provided in FIG. 13. Without intending to limit the range of alternative medications or supplements that may be recorded using the Medications/Supplements admin screen, such medications and supplements include any of the medications and supplements listed in a standard drug formulary, such as the Physician's Desk Reference, which may include any of the following: Lipitor, digoxin, aspirin, penicillin, vitamin D, melatonin, and selenium.

This admin screen arises in response to clicking on inputs selector menu button 1701 (i.e., the numeral 170 followed by the letter el) with a first signal, i.e., a left-click of a computer mouse, for example. The Medications/Supplements admin screen 1300 includes section 1310 for recital of the name for a given medication or supplement. The medication or supplement is commonly selected from drop menu 1312 or, if the particular medication or supplement is not listed in the drop menu, then one can alternatively select “other” in the menu and then recite the name of the medication or supplement in subsection 1314. Importantly, one enters the starting date regarding the taking of a given medication or supplement in subsection 1316. Typically, medications or supplements are taken over a period of time that, during the phase of taking the medication or supplement, one checks box 1318a to indicate that the medication/supplement is being taken on an ongoing basis. When the taking of the medication or supplement ceases, the stop date is entered in subsection 1318. The dose for a given administration of the medication or supplement is entered into subsection 1320; and the frequency for taking the medication or supplement is entered into subsection 1322. The medication or supplement can be explained or otherwise expanded upon by adding remarks in the subsection labeled Remarks 1330. In that case, the user enters remarks in the appropriate area of subsection 1330 and if the remarks so entered are appropriately used as note regarding the administration then the box indicating Notes 1330a is checked; if the remarks provide explanation for an alert due to some result or event of the past selected for the user to be mindful of, the double-exclamation point icon is included on the home screen and the check box 1330b is marked; alternatively, the remarks may be used as a reminder for a future act, where a reminder icon (an “alarm clock” sketch or cartoon [symbol] per the illustrated embodiment of the figures) appears on the home screen, and, for that purpose, the check box 1330c is marked. The user may also think it appropriate that his/her remarks input into section 1330 ought to be emailed to someone, in which case the ampersand icon 1332 is clicked upon and the language already input into section 1330 appear in the message portion of an email composition screen.

Particularly appropriate to this admin screen, if one with drug prescription authority is entering information, an order for the prescription can be entered directly. First, the authorized prescriber would check box 1340a indicating that an order was to be entered by way of this admin screen. What was to be ordered is selected using the drop menu in subsection 1340: Only those items included in the drop menu will be acceptably ordered using this admin screen under this embodiment of the invention. If the order is for an ethical drug requiring a prescription, then a pop-up screen emerges for the authorized prescriber to enter his/her username and password and, if the username and password are appropriate per the information entered into the MSC System, then a direct communication between the MSC System will be opened names and locations of pharmacies are set forth and selected for passing the prescription order to a selected pharmacy for filling the prescription. Of course, additional safeguards are in place to assure that the authorized prescriber is uniquely identified by the pharmacy as well, which is a function of additional program requirements under control of the pharmacy and, accordingly, not a part of the present invention. But making the direct communication is indeed part of the present invention, using methods well-known in the art.

All other aspects of the Medications/Supplements admin screen shown in FIG. 13 conform to those of the other admin screens.

An embodiment of the admin screen for entering information relating to life style aspects of the patient's life that may have impact on his/her health is provided in FIG. 14. Without intending to limit the range of alternative life style characteristics that may be recorded using the Life Style admin screen, such life style characteristics include any of the following: marital status, employment status, living situation, alcohol intake, recreational drug intake, yoga, meditation, exercise, music, massage, tai chi, prayer, and the like.

This admin screen arises in response to clicking on input selector (101) menu button 170m with a first signal, i.e., a left-click of a computer mouse, for example. The Life Style admin screen 1400 includes section 1410 for recital of the name for a given life style characteristic. The life style characteristic is commonly selected from drop menu 1412 or, if the particular life style characteristic is not listed in the drop menu, then one can alternatively select “other” in the menu and then recite the name of the life style characteristic in subsection 1414. Importantly, one enters the starting date regarding the start (or recognition of the start) of the life style characteristic in subsection 1416. Of course, life style characteristics exist over a period of time that, when ongoing, one checks box 1418a to indicate that the life style characteristic is ongoing. If the life style characteristic ceases, the stop date is entered in subsection 1418. If the life style characteristic entails a treatment, the treatment is entered at subsection 1420. If the user presents a request of another upon reviewing the life style characteristic entry, the request is entered into subsection 1422. If the user elects to enter further explanation or other such note, such information is entered into subsection 1430 and the box 1430a is checked. If the remarks provide explanation for an alert due to some result or event of the past selected for the user to be mindful of, the double-exclamation point icon is included on the home screen and the check box 1430b is marked; alternatively, the remarks may be used as a reminder for a future act, where a reminder icon (an “alarm clock” sketch or cartoon [symbol] per the illustrated embodiment of the figures) appears on the home screen, and, for that purpose, the check box 1430c is marked. The user may also think it appropriate that his/her remarks input into section 1430 ought to be emailed to someone, in which case the ampersand icon 1432 is clicked upon and the language already input into section 1430 appear in the message portion of an email composition screen. All other aspects of the Medications/Supplements admin screen conform to those of the other admin screens.

An embodiment of the admin screen for entering alerts or reminders is provided in FIG. 15. Without intending to limit the range of alternative alerts or reminders that may be recorded using the Alerts/Reminders admin screen, such alerts and reminders include any of the following: date of scheduled office appointment; date for checking status of prescription drugs or supplements; date of scheduled therapy session; reminders, return office visit, perform a test, call the doctor's office, alerts regarding allergy or side effect, and the like.

This admin screen arises in response to clicking on input selector button 170g with a first signal, i.e., a left-click of a computer mouse, for example. The Alerts/Reminders admin screen 1500 includes section 1510 for recital of the name for a given alert. The alert is commonly selected from drop menu 1512 or, if the particular alert is not listed in the drop menu, then one can alternatively select “other” in the menu and then recite the name of the alert in subsection 1514. Importantly, one enters the starting date regarding the first entry of a given alert in subsection 1516. Typically, alerts will have a stopping point, e.g., stopping when the alert is no longer operative due to a change of circumstance in a patient's health or data from a report was entered or a change in the patient's life that obviates operativeness of the alert. Accordingly, alerts are commonly in place over a period of time that, during the phase of the alert being operative, one checks box 1518a to indicate that the alert is considered appropriately ongoing. When the circumstances change and the alert is no longer appropriate or operative, the stop date is entered in subsection 1518.

The Alerts/Reminders admin screen 1500 also includes in section 1510 a place for recital of the name for a given reminder. The reminder is selected from drop menu 1520, after which a reminder icon appears on the home screen. One can also increase likelihood of the reminder icon working by having an email sent to oneself or another, which is accomplished by clicking on the ampersand 1522. Reminders, pertaining to a future event, are recited with regard to indeed what the reminder is regarding, which information is entered into subsection 1530. If the user indicates that the remarks are of substance and should be cataloged as a note, then box 1530a is checked and indeed the now note will be included among supporting documents of the group data report included on the Reports/Notes admin page. If the information provided regarding the reminder should be made yet more prominent for the user, it can be cataloged as an alert by checking box 1530c, in which case a double-exclamation point icon will appear on the home screen and the information entered will appear as a line item in the group data report for the Alerts/Reminders admin screen.

All other aspects of the Alerts/Reminders admin screen conform to those of the other admin screens.

Chronological data reports can be provided with respect to all categories of data or to a particular category of data; and with respect to a particular day, or a particular set of days, or all time (i.e., a chronological data report including all available data for all categories or a particular category of data), by means of the following:

A. Referring to Figure lA that illustrates one embodiment of the home screen, one selects a chronological data report of all categories of data for a particular date in one of two ways:
1. Move the slidable line 102 by placing the cursor directly on any part of the slidable line itself apart from the triangular portion thereof and holding any signal thereupon while moving the computer mouse to cause the slidable line to intersect the time line 160 at a point that is consistent with a date of interest; or
2. Click on the Chrono Data hot button 180a that causes a pop-up screen to emerge (not shown) for entry of certain data and inquiries including entry of a date of interest in the start date field only.

B. Again referring to Figure lA that illustrates one embodiment of the home screen, one selects a chronological report of all categories of data for a range of dates in one of two ways:
3. Move the slidable line 102 in part by placing the cursor directly on its left triangular portion 102a and holding any signal thereupon while moving the computer mouse to cause the slidable line to split into two such lines and move the left such line to intersect the time line 160 at a point that is consistent with a first date of interest, and then by placing the cursor directly on its right triangular portion 102b and holding any signal thereupon while moving the computer mouse to a point that is consistent with a second date of interest on time line 160; or
4. Click on the Chrono Data hot button 180a that causes a pop-up screen (not shown) to emerge for entry certain data and inquiries including entry of a first date of interest in the start date field and a second date of interest in the end date field.

The movement of the slidable line 102 can be accomplished, holding any signal thereupon, i.e., in one embodiment, holding a right- or left-click, and, while holding the signal, moving the cursor to a location consistent with the date of interest. Upon having moved the slidable line 102 to intersect the point on the timeline 160 that correlates to the date of interest or having entered the date of interest in the aforementioned pop-up arising after clicking hot button 180a and contacting the slidable line or the pop-up with a second signal, then all data that was previously entered into the MSC System for the date of interest will appear in a chronological data report, as presented in FIG. 16A, consistent with the method of section A above. Each line of the report presents data entered from a different support document, and the columns that are shown present the following categories of data: Name (column 431), Start Date (column 433), End Date or Ongoing (column 434), Value (column 432), Dose (column 436), Frequency (column 437), Remarks (column 441), Orders (column 438), View (column 442), Edit (column 443), Upload (column 444), Download (column 445), and Delete (column 446).

Similarly, one can generate a chronological data report for a range of dates of interest in one of the two ways described in section B above. As illustrated in FIG. 16B, the documents resulting in such a report may range between the dates of the range entered, including all of the same fields of information as set forth above with regard to a single date of interest.

To generate a report of all data available, one can click on the Chrono Data hot button 180a, enter no date on the inquiry pop-up, select enter, and the next screen will be as shown in FIG. 16B for all data that was entered.

To generate a report of data for a particular group or set of groups, i.e., one of the subsets of data represented in the hot buttons 170, one selects Group Data 180b resulting in a pop-up that recites the same set of categories as are set forth on buttons 170 and then further selects one or more of said categories of available data by highlighting the group data button or buttons and selecting enter on the pop-up screen.

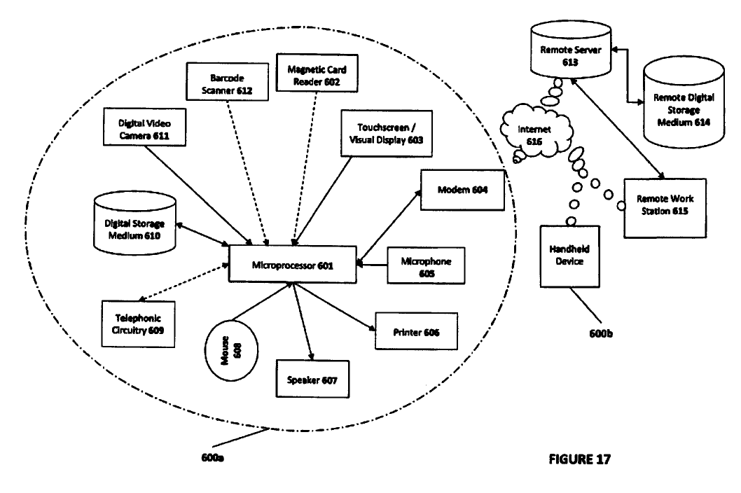

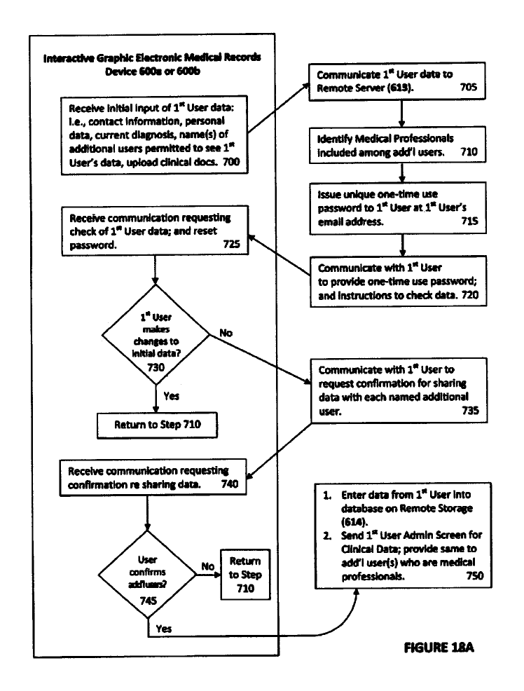

One computer system that employs the various reports and data entry as set forth herein above is represented in FIG. 17. In particular, the computer system includes, at minimum, a microprocessor 601 for manipulation and organization of data inputs including, without limitation intended, a digital video camera 611, a barcode scanner 612, a magnetic card reader 602, a touchscreen/visual display 603, a microphone 605, and a mouse 608. Outputs include a printer 606 and a speaker 607. In addition, there is preferably telephonic circuitry 609 and a modem 604 for entry and readout of data and, in the case of use of the modem, access to remote inputs via the internet; and a digital storage medium 610 for local data storage. A modem 604 is also included, preferably, for accessing data and receiving additional inputs from offsite remote server 613 and remote digital storage medium 614, as well as communication with a handheld device 600b and a remote work station 615. For those users interested in heightened security, access to remote stations can be cut off by disabling the modem 604, in which case, in one embodiment, all data can be downloaded onto a portable storage device, such as a USB storage device, for review on a remote computer station. Alternatively, the data of the system can be copied onto a smart card and then accessed on a remote computer using a smart card reader.

One embodiment of a computer system that embraces all or a subset of the various reports and data entry screens set forth herein above is represented in FIGS. 18A-C. In particular, referring to FIG. 18A, a patient's data (i.e., data of a first user) can be input into a computer system as represented by device 600a or 600b shown in FIG. 17. As indicated for step 700, data to be input includes contact information, personal data, current diagnosis, name(s) of additional users permitted access to the patient's data and/or permitted to upload clinical documents. Step 705 relates to communicating the patient's data to a remote server 613 as well as to identify medical professionals included among the users of the system (step 710), issue unique one-time use password to the patient at patient's email address (step 715), and separately communicate with the patient to provide one-time use password along with instructions to inspect data (step 720). Thereafter, the patient (1^{st} User) receives a communication requesting check of his/her data, as well as resetting of the password (step 725). If the patient makes changes to initial data, then the system returns to step 710 for identifying medical professionals included among the users, and continues down the same path set forth above thereafter. If the patient accepts the initial data, then the system requests confirmation from the patient for sharing his/her data with each named additional user (who can include physicians and other health professionals treating or advising the patient as well as other trusted advisors chosen or accepted by the patient). The patient can receive a communication requesting that the data be shared with a third party (step 740), which can be refused (in which case the system returns to step 710 above) or accepted. In the latter case, pursuant to step 750, data of the patient (i.e., the 1^{st} User) is entered into the database on Remote Storage 614 and the 1^{st} User Admin Screen for Clinical Data is provided to medical professionals who are named additional users of the system.

For entry of data into the system, an admin screen is selected and clinical documents are entered accordingly (Step 755), as indicated in FIG. 18B. In one embodiment, the clinical documents are uploaded to remote server 613 (step 760) and such documents are stored in Remote Storage 614 (step 765). Separately, the data included on such documents need to be entered (which is the question of step 770) unless the system is able to read the uploaded document directly and thereby enter the contained information, which is a capability available in certain embodiments of the present invention. If the data of the stored document was not entered, then a Δ icon is entered on the home screen to indicate that a document needs to be entered. And if the data of the stored document was entered, then the A icon, if previously entered onto the home screen, is removed (step 776); and the system checks that the entered data comport to the selected Admin screen (step 777).

If the data do not comport to the selected Admin screen, then the Δ icon is restored to the home screen and step 770 is repeated. However, if the data do indeed comport to the selected Admin screen, then the entered data are further analyzed to determine whether or not they derive from a periodically repeated assay (step 779). If so, the data are entered into the first section of the Home Screen as part of Line Graph 110 and Field 1 (step 780). But if not, then the data are analyzed to determine if they refer to a one-time event (Step 781). If so, then the data are entered into the second section of the Home Screen as part of the Vertical Markings 120 and Field 2 (Step 782). But if not, then the data are analyzed to determine whether they relate to a long-term event (Step 783). If so, then the data are entered into Section 3 of the Home Screen (i.e., the bar graph 130) and Field 3 (Step 784).

Next, step 785 includes the inquiry whether the entered data are reports or notes; if yes, then the data are entered into Section 4 of the Home Screen (relating to Reports and Notes 140) and Field 4. But if not, then the entered data are queried whether or not they are Communications (Step 787). If so, the data are entered in Section 5 of the Home Screen (communications 150) and Field 5. And, if not, then the data are entered in Remarks (Step 789).

With regard to a module relating to cardiology, a drop menu for such a module preferably includes recital of the following:

A. Standard patient measurements, including: (1) height, (2) weight, (3) blood pressure, (4) resting pulse, and (5) temperature; each taken at each office visit as well as reported periodically by the patient between visits;

B. Common coronary diseases or conditions, including: (1) cardiac auscultation, (2) peripheral artery disease, (3) ophthalmic fundus, (4) total cholesterol, (5) low density cholesterol, (6) triglycerides, (7) high density lipids (HDL), (8) hemoglobin AlC, (9) electrocardiogram—latest, (10) stress test—latest, (11) cardiac calcium score;

C. Medical examination history, including: (1) cardiac risk calculator result (using device found at http://evrisk.mvm.ed.ac.uk/calculator/calc.asp), (2) latest medical history, (3) latest physical exam;

D. Survey of cardiovascular disease-indicator symptoms, including: (1) chest pain, (2) neck and jaw pain, (3) palpitation, (4) sweating, (5) shortness of breath, (6) claudication, (7) dizziness, (8) fatigue;
E. Test Results, incluing: (1) electrocardiogram, (2) holter monitor, (3) oxygen saturation, (4) arterial blood gases, (5) exercise stress test, (6) nuclear stress test, (7) carotid ultrasound, (8) holter monitor, (9) echocardiography, (10) coronary artery calcium imaging score, (11) coronary angiogram;
F. Medications: (1) aspirin, (2) cholesterol medication, (3) clot-dissolving drugs, (4) nitrates, (5) diuretics, (6) blood pressure medication.

While preferred embodiments of the present invention have been shown and described herein, it will be obvious to those skilled in the art that such embodiments are provided by way of example only. Numerous variations, changes, and substitutions will now occur to those skilled in the art without departing from the invention or the definitions provided herein for clearly recording inventor's conception and embodiments thereof. It should be understood that various alternatives to the embodiments of the invention described herein may be employed in practicing the invention.

### Definitions

All technical terms have the standard accepted meaning in the art to which the present disclosure applies.

The following terms are generally used as defined in this section unless specifically recited otherwise in the specification set forth herein, which variations present reasonable extensions of the concepts as presented here as well as reasonably equivalent embodiments that are contemplated to be aspects of the present invention.

The term “screen” as used herein shall have the meaning of the appearance and content of a computer display or that of another electronic device that can retrieve and display such appearance and content, which appearance and content include any one or combination of a set of words, graphics, hypertext (or other means for hyperlinking text or other symbol(s) included on a screen with a second screen or location on the internet), hypermedia (i.e., means for hyperlinking text or other symbol(s) included on a screen with a video file, an audio file, or a program for generating a video file or an audio file) and/or means for entry or editing of data, uploaded documents, or uploaded media, or generating new media, which one or combination appear on a single electronic page.

The term “home screen” or “MSC Screen” as used herein shall have the meaning of a screen that displays at least a line graph of repeated tests, a bar graph of long-term events, and a recital of one-time events, all of which are displayed with reference to the same time line.

The term “admin screen” as used herein shall have the meaning of a screen that arises in response to a signal that is implemented with respect to a hyperlink element included on the home screen where an event, data or a communication is reflected; which admin screen displays a chronological list of events, data reports, or communications and a means to enter or edit said events, data reports, or communications that relate medically and/or chronologically to the hypertext or hypermedia where the signal is implemented.

The term “event” as used herein shall have the meaning of a health-related incident, procedure, or therapy.

The term “one-time event” as used herein shall have the meaning of an event that occurs within a one or two day period of time but has a realized or (potential) longer-term effect, e.g., a diagnostic test or a car accident; displayed as a point with respect to the time line.

The term “extended event” or “long-term event” as used herein shall have the meaning of an event that occurs over time in excess of two days, such as a common course of physical therapy or drug therapy or a period of incarceration or other life situation having likely health impact; displayed as a bar with respect to the time line and/or as points signifying start and/or stop on the time line.

The term “hyperlink element” or “hot button” as used herein shall have the meaning of a word (i.e., hypertext) or symbol that, when clicked upon or otherwise signaled, results in the appearance on the computer display of a second screen or internet site. The hyperlink element, for example, can be a word or words encircled by a dashed line, as in: Home ; the exemplified hot button shown here will result in viewing the home screen upon being clicked by a mouse.

The term “signal” or “click” as used herein shall have the meaning of an electronic targeting of an appropriate hyperlink element on one screen that results in the display of a second screen; for example, clicking on the hyperlink element included in the definition of that term (immediately above), if located on any screen of the MSC system (apart from the home screen), would result in the appearance of the home screen. From the home screen. Such signals can be generated using any input device, such as, without limitation intended, keyboard, computer mouse, track pad, trackball, touch screen, voice command identifying the x-y coordinates of a target symbol, or the like; and different signals can be generated using, for example, right-click versus left-click on a computer mouse or trackball, single-strike versus double-strike on a track pad or touch screen, or any of other methods that have been developed or will be developed to indicate different signals used in the context of computer software generally. (Note: Use of the term “click” historically derives from the sound generated when selecting an object on a screen with a computer mouse, however, in the context of this specification, clicking is defined as synonymous with signaling.)

The term “first signal” as used herein shall have the meaning of an electronic signal generated using any input device exemplified above which, upon implementation with respect to a single symbol or a set of symbols resident on the home page, results in the appearance on the display of a second screen. In the context of a computer mouse, a first signal is synonymous with a “left click,” i.e., the depressing of the left-hand signal button on the mouse.

The term “second signal” as used herein shall have the meaning of an electronic signal that is distinguishable from the first signal and is generated using any input device exemplified above which, upon implementation with respect to a single symbol or a set of symbols resident on the home page, results in the appearance on the display of a second screen. In the context of a computer mouse, a second signal is synonymous with a “right click,” i.e., the depressing of the right-hand signal button on the mouse.

The term “icon” as used herein shall have the meaning of a symbol signifying an event, a note, a warning, a communication, a data point.

The term “event icon” as used herein shall have the meaning of an icon indicative of a short-term event or a long-term event, either of which icons usually have the form of an acronym, abbreviation, or phrase suggestive of the so-symbolized event.

The term “note icon” as used herein shall have the meaning of an icon indicative of a written communication, such as an order from a medical practitioner or, from the medical practitioner or the patient, requests for additional information, suggestions of alternative or additional treatment, and summations of status of current treatment or health of patient.

The term “warning icon” as used herein shall have the meaning of an icon that signifies that an order may not yet have been filled, completed or initiated with respect to a prescription or a treatment, as appropriate.

The term “communication icon” as used herein shall have the meaning of a distinguishable icon indicative of an email communication (e.g., “@”), a video email, a video conference, a chat, a phone call, or a paper message.

The term “supporting document” as used herein shall have the meaning of a document issued by a blood chemistry laboratory, a pathology laboratory, or a medical professional reporting raw or manipulated data, observations, and/or reasoned conclusions regarding the result of a test, procedure, or office visit, as appropriate; or a communication file that is an email, audio or video recording, or other written, oral, or visual conveyance of information.

The term “slidable line” as used herein shall have the meaning of an indicator of one or two points on the time line, where all patient-specific information of a single date are selected if a single slidable line is used or, where two slidable lines are used to identify two separate dates, the patient-specific information associated with the range of dates between and including the two separate dates is selected.

The term “treatment” or “protocol” as used herein shall have the meaning of a prescribed medicine, an over-the-counter medicine or supplement, surgical procedure or other therapy; can be a short-term event or a long-term event.

The use of the terms “a” and “an” and “the” and similar referents in the context of describing the invention is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate better the feature and does not pose a limitation on the scope of the disclosure unless otherwise claimed. No language in the specification should be construed as indicating any non-claimed element as essential to the disclosure.

While the foregoing description of the present system has been shown and described in connection with various particular embodiments and applications thereof, it has been presented for purposes of illustration and description and is not intended to be exhaustive or to limit the electronic system to the particular embodiments and applications disclosed. It will be apparent to those having ordinary skill in the art that a number of changes, modifications, variations, or alterations to the system as described herein may be made, none of which depart from the spirit or scope of the present disclosure. The particular embodiments and applications were chosen and described to provide the best illustration of the principles of the system and its practical application to thereby enable one of ordinary skill in the art to utilize the system in various embodiments and with various modifications as are suited to the particular use contemplated. All such changes, modifications, variations, and alterations should therefore be seen as being within the scope of the present disclosure.

It is intended that the following claims define the scope of the invention and that methods and structures within the scope of these claims and their equivalents be covered thereby.

What is claimed is:

1. A method for enrolling a participant in a clinical study, said method comprising:
a. Providing:
i. a home screen having a first dimension and a second dimension, an icon that is connected to patient-specific information, and a time line that defines time points along the first dimension;
ii. a supporting document of patient-specific information;
iii. an admin screen for entering, editing, downloading, or uploading patient-specific information;
iv. a means for accessing patient-specific information associated with a single date or a range of dates;
v. a chronological data report; and
vi. a first signal, a second signal, and a third signal;
vii. a database of clinical studies seeking the participant;
b. Contacting on the home screen:
i. the icon with the first signal for accessing supporting document;
ii. the icon with the second signal for accessing the admin screen; or
iii. the means for accessing patient-specific information associated with a single date or a range of dates with the third signal for accessing the chronological data report of patient-specific information associated with the single date or the range of dates.
